(19) United States
(12) Patent Application Publication
(10) Pub. No.: US 2025/0261244 A1
(43) Pub. Date: Aug. 14, 2025

(54) SUB-BAND FULL-DUPLEX PHYSICAL RANDOM ACCESS CHANNEL TRANSMISSION

(71) Applicant: QUALCOMM Incorporated, San Diego, CA (US)

(72) Inventors: Chiranjib SAHA, Lakeside, CA (US); Shankar KRISHNAN, Poway, CA (US); Muhammad Sayed Khairy ABDELGHAFFAR, San Jose, CA (US); Umesh PHUYAL, San Diego, CA (US); Prasada Veera Reddy KADIRI, San Diego, CA (US)

(21) Appl. No.: 18/953,730

(22) Filed: Nov. 20, 2024

Related U.S. Application Data
(60) Provisional application No. 63/552,049, filed on Feb. 9, 2024.

(51) Int. Cl. H04W 74/0833; H04L 5/14

(52) U.S. Cl. CPC H04W 74/0833; H04L 5/14

(57) ABSTRACT

Various aspects of the present disclosure generally relate to wireless communication. In some aspects, a user equipment (UE) may receive configuration information indicating a random access channel (RACH) configuration applicable to sub-band full-duplex (SBFD) symbols. The UE may transmit a physical random access channel (PRACH) transmission in a RACH occasion (RO) of one or more ROs determined in accordance with the RACH configuration. Numerous other aspects are described.

### CROSS-REFERENCE TO RELATED APPLICATION

This Patent Application claims priority to U.S. Provisional Patent Application No. 63/552,049, filed on Feb. 9, 2024, entitled “SUB-BAND FULL-DUPLEX PHYSICAL RANDOM ACCESS CHANNEL TRANSMISSION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for sub-band full-duplex physical random access channel transmission.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various

telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be configured to cause the UE to receive configuration information indicating a random access channel (RACH) configuration applicable to sub-band full-duplex (SBFD) symbols. The one or more processors may be configured to cause the UE to transmit a physical random access channel (PRACH) transmission in a RACH occasion (RO) of one or more ROs determined in accordance with the RACH configuration.

Some aspects described herein relate to a network node for wireless communication. The network node may include one or more memories and one or more processors coupled to the one or more memories. The one or more processors may be configured to cause the network node to transmit configuration information indicating a RACH configuration applicable to SBFD symbols. The one or more processors may be configured to cause the network node to receive a PRACH transmission in an RO of one or more ROs determined in accordance with the RACH configuration.

Some aspects described herein relate to a method of wireless communication performed by a UE. The method may include receiving configuration information indicating a RACH configuration applicable to SBFD symbols. The method may include transmitting a PRACH transmission in an RO of one or more ROs determined in accordance with the RACH configuration.

Some aspects described herein relate to a method of wireless communication performed by a network node. The method may include transmitting configuration information indicating a RACH configuration applicable to SBFD symbols. The method may include receiving a PRACH transmission in an RO of one or more ROs determined in accordance with the RACH configuration.

Some aspects described herein relate to a non-transitory computer-readable medium that stores a set of instructions for wireless communication by a UE. The set of instructions, when executed by one or more processors of the UE, may cause the UE to receive configuration information indicating a RACH configuration applicable to SBFD symbols. The set of instructions, when executed by one or more processors of the UE, may cause the UE to transmit a PRACH transmission in an RO of one or more ROs determined in accordance with the RACH configuration.

Some aspects described herein relate to a non-transitory computer-readable medium that stores a set of instructions for wireless communication by a network node. The set of instructions, when executed by one or more processors of the network node, may cause the network node to transmit configuration information indicating a RACH configuration applicable to SBFD symbols. The set of instructions, when executed by one or more processors of the network node, may cause the network node to receive a PRACH transmission in an RO of one or more ROs determined in accordance with the RACH configuration.

Some aspects described herein relate to an apparatus for wireless communication. The apparatus may include means for receiving configuration information indicating a RACH configuration applicable to SBFD symbols. The apparatus may include means for transmitting a PRACH transmission in an RO of one or more ROs determined in accordance with the RACH configuration.

Some aspects described herein relate to an apparatus for wireless communication. The apparatus may include means for transmitting configuration information indicating a RACH configuration applicable to SBFD symbols. The apparatus may include means for receiving a PRACH transmission in an RO of one or more ROs determined in accordance with the first RACH configuration or in an RO in an uplink sub-band in one or more SBFD symbols in accordance with the second RACH configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating examples of full-duplex (FD) communication in a wireless network, in accordance with the present disclosure.

FIG. 5 is a diagram illustrating an example of sub-band full-duplex (SBFD) activation, in accordance with the present disclosure.

FIG. 6 is a diagram illustrating an example of a four-step random access procedure, in accordance with the present disclosure.

FIGS. 7A-7E are diagrams illustrating examples of mapping synchronization signal blocks to random access channel occasions, in accordance with the present disclosure.

FIGS. 8A-8C are diagrams illustrating an example associated with SBFD physical random access channel (PRACH) transmission, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIGS. 11-12 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

“Full-duplex (FD) communication” in a wireless network refers to simultaneous bi-directional communication between devices in the wireless network. Sub-band full-duplex (SBFD) is a type of FD communication in which a network node may transmit a downlink communication and receive an uplink communication at the same time, but on different frequency resources. For example, the frequency resources used for downlink communication (e.g., a downlink sub-band) may be separated from the frequency resources used for uplink communication (e.g., an uplink sub-band), in the frequency domain, by a guard band.

A user equipment (UE) and a network node may perform a random access procedure to establish a radio resource control (RRC) connection between the UE and the network node. The UE may initiate the random access procedure by transmitting a physical random access channel (PRACH) transmission including a PRACH preamble to the network node. In some examples, the network node may broadcast different synchronization signal blocks (SSBs) (also referred to as synchronization signal (SS)/physical broadcast channel (PBCH) blocks) using different beams. The SSBs may be associated with respective SSB indexes (or SS/PBCH block indexes). The UE may detect one or more SSBs broadcast by the network node and measure a signal strength of each detected SSB. In some examples, the UE may select a strongest SSB and transmit the PRACH transmission using the beam associated with the selected SSB. In such examples, the UE may transmit the PRACH transmission in a random access channel (RACH) occasion (RO) associated with the selected SSB. For example, the network node may transmit (e.g., in a system information block (SIB) type 1 (SIB1)), and the UE may receive, a random access configuration that indicates parameters that define a mapping between SSBs and ROs (e.g., time and frequency resources available for transmitting a PRACH transmission). The UE may determine the RO associated with the selected SSB based in the mapping between the SSBs and the ROs. The network node may determine the selected SSB (and the corresponding beam) based on the RO in which the PRACH transmission is received.

In some examples, SBFD communication may be used for random access by a UE (e.g., an SBFD-aware UE). An SBFD-aware UE (also referred to as an SBFD-capable UE or an SBFD UE) may be capable of receiving downlink transmissions in a downlink sub-band of an SBFD slot or symbol or transmitting uplink transmissions in an uplink sub-band of an SBFD slot or symbol. In some examples, an SBFD-aware UE may use SBFD symbols to transmit a PRACH signal (e.g., to initiate a random access procedure). For example, an SBFD-aware UE in an RRC idle or inactive state or in an RRC connected state may transmit a PRACH transmission in SBFD symbols to initiate a random access procedure. In such examples, the SBFD-aware UE may map SSBs to ROs in uplink symbols (e.g., in uplink slots) and/or in SBFD symbols (e.g., in SBFD slots). However, non-SBFD-aware UEs (also referred to as legacy UEs) may be capable of receiving downlink transmissions in a downlink sub-band of an SBFD slot or symbol, but may not be capable of transmitting uplink transmissions in an uplink sub-band of an SBFD slot or symbol. Accordingly, such legacy UEs may map SSBs only to ROs in uplink symbols (e.g., in uplink slots), and may not map SSBs to ROs in SBFD symbols (e.g., in SBFD slots). In some examples, in a case in which SBFD-aware UEs map SSBs to ROs spread across SFBD and uplink slots, the mapping of the SSBs to the ROs may be different for the SBFD-aware UEs and the legacy UEs in one or more uplink slots. This may cause ambiguity in the mapping of the SSBs to the ROs, which may result in the network node not being able to determine the correct mapping to an SSB for a PRACH transmission received in an RO from a UE.

Various aspects relate generally to PRACH transmission in SBFD symbols. Some aspects more specifically relate to a random access configuration associated with PRACH transmission in SBFD symbols. In some aspects, a network node may transmit, and a UE may receive, configuration information indicating a first RACH configuration for uplink symbols and a second RACH configuration for SBFD symbols. For example, the first RACH configuration may indicate a first mapping of SSBs to ROs in uplink symbols, and the second RACH configuration may indicate a second mapping of SSBs to ROs in SBFD symbols. The UE may transmit, and the network node may receive, a PRACH transmission in accordance with the first RACH configuration or the second RACH configuration. For example, the UE may transmit the PRACH transmission in an RO in one or more uplink symbols in accordance with the first RACH configuration, or the UE may transmit the PRACH in an RO in an uplink sub-band in one or more SBFD symbols.

Particular aspects of the subject matter described in this disclosure can be implemented to realize one or more of the following potential advantages. In some examples, by indicating different RACH configurations for uplink symbols and SBFD symbols that configure separate mappings of SSBs to ROs in uplink symbols and SBFD symbols, the described techniques can be used to prevent ambiguity due to different mappings of SSBs to ROs caused by SBFD-aware UEs mapping SSBs to ROs across SBFD and uplink slots and legacy UEs mapping SSBs to ROs only in uplink slots. As a result, accuracy may be improved with respect to the network node correctly determining a selected SSB (and a corresponding beam) based on an RO in which a PRACH transmission is transmitted by a UE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

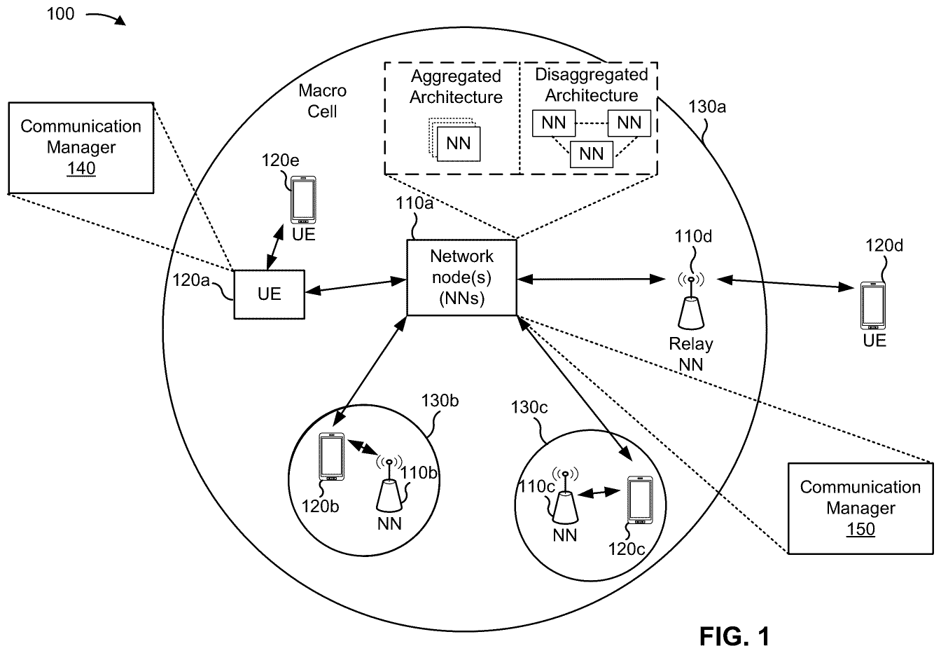

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, PRACH extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network transmission, or non-coherent joint transmission (NC-JT).

In some aspects, the UE 120 may include a communication manager 140. As described in more detail elsewhere herein, the communication manager 140 may receive configuration information indicating a RACH applicable to SBFD symbols; and transmit a PRACH transmission in an RO of one or more ROs determined in accordance with the RACH configuration. Additionally, or alternatively, the communication manager 140 may perform one or more other operations described herein.

In some aspects, the network node 110 may include a communication manager 150. As described in more detail elsewhere herein, the communication manager 150 may transmit configuration information indicating a RACH configuration applicable to SBFD symbols; and receive a PRACH transmission in an RO of one or more ROs determined in accordance with the RACH configuration. Additionally, or alternatively, the communication manager 150 may perform one or more other operations described herein.

As indicated above, FIG. 1 is provided as an example. Other examples may differ from what is described with regard to FIG. 1.

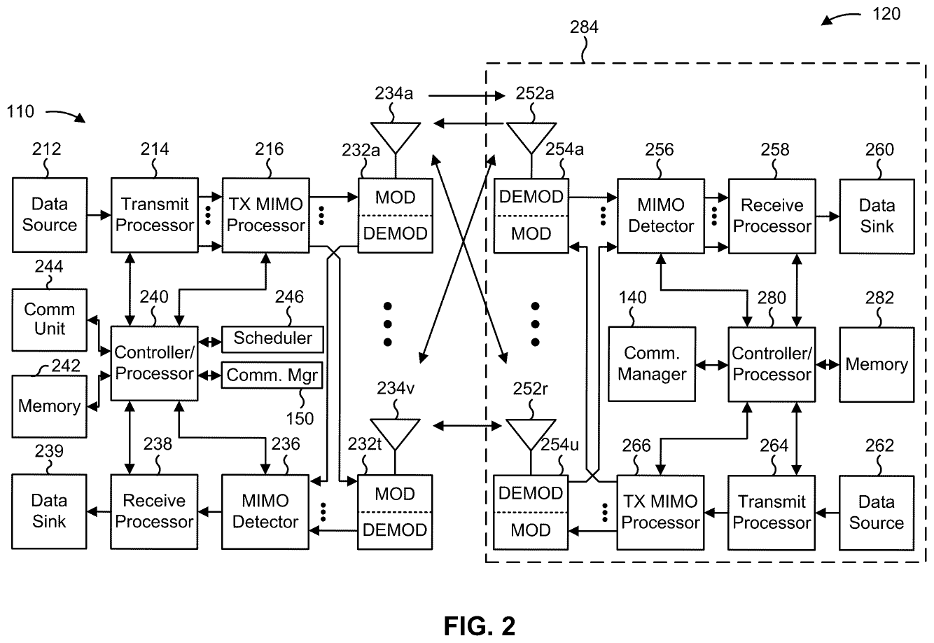

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

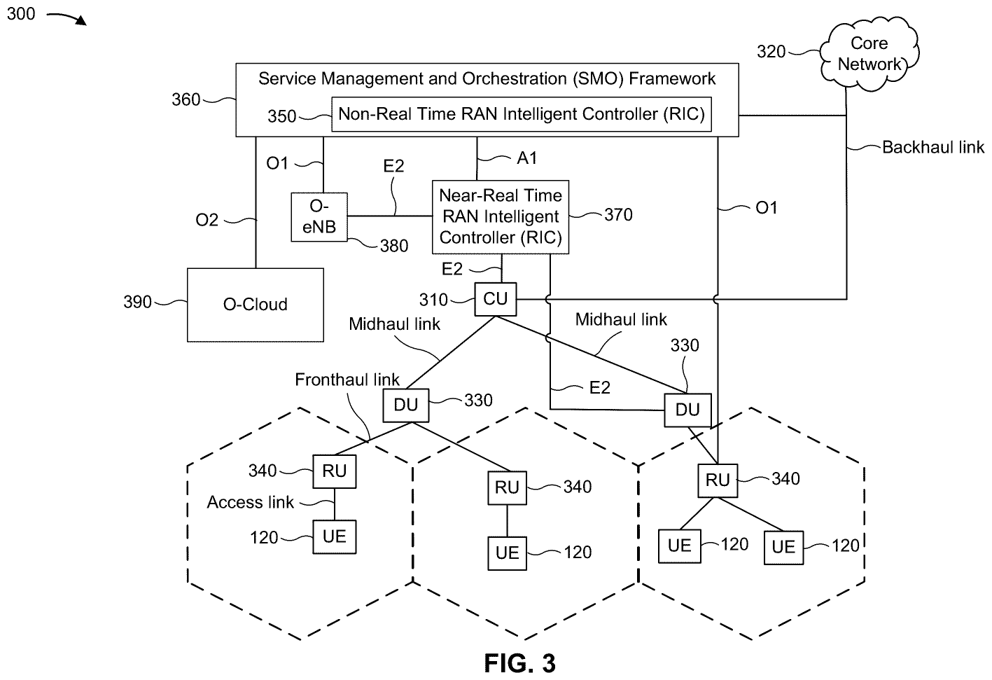

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

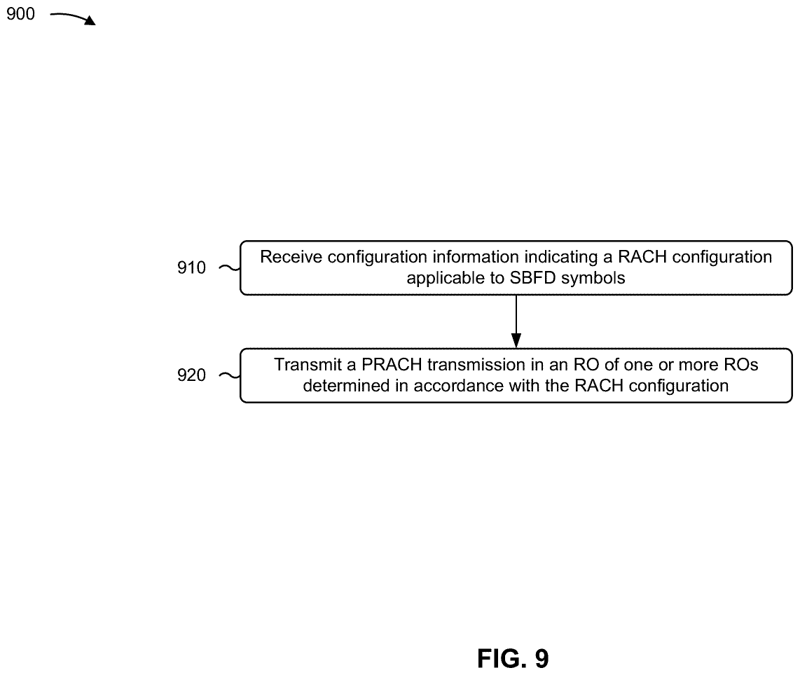

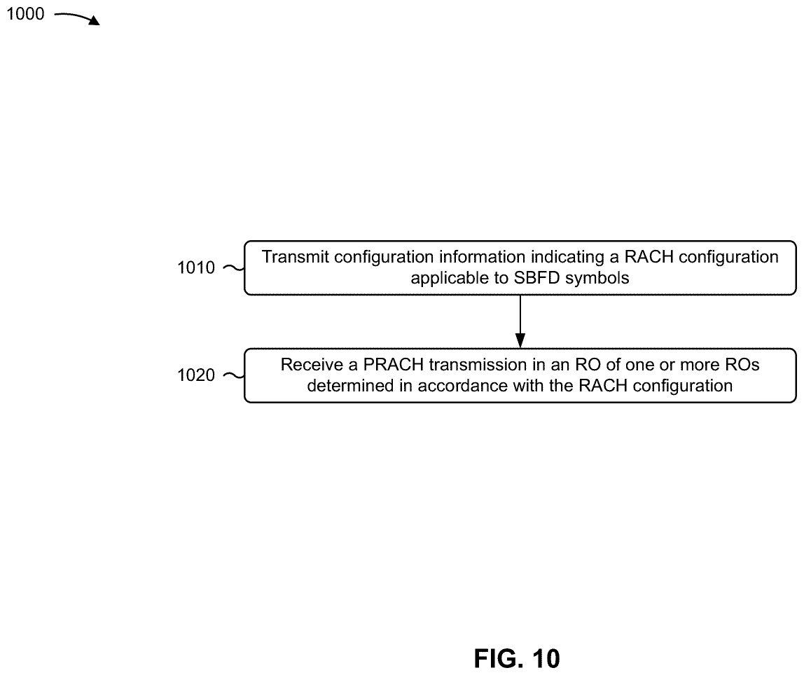

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with SBFD PRACH transmission, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, a UE (e.g., the UE 120) includes means for receiving configuration information indicating a RACH configuration applicable to SBFD symbols; and/or means for transmitting a PRACH transmission in an RO of one or more ROs determined in accordance with the RACH configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting configuration information indicating a RACH configuration applicable to SBFD symbols; and/or means for receiving a PRACH transmission in an RO of one or more ROs determined in accordance with the RACH configuration. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

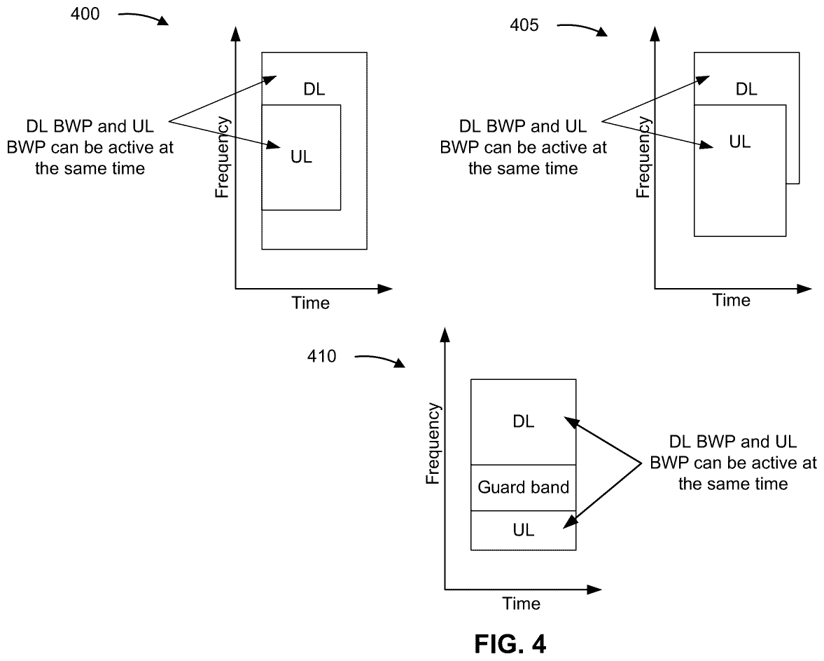

FIG. 4 is a diagram illustrating examples 400, 405, and 410 of FD communication in a wireless network, in accordance with the present disclosure. “Full-duplex communication” (or “FD communication”) in a wireless network refers to simultaneous bi-directional communication between devices in the wireless network. For example, a UE operating in an FD mode may transmit an uplink communication and receive a downlink communication at the same time (for example, in the same slot or the same symbol). A network node operating in an FD mode may transmit a downlink communication and receive an uplink communication at the same time (for example, in the same slot or the same symbol). “Half-duplex (HD) communication” in a wireless network refers to unidirectional communications (for example, only downlink communication or only uplink communication) between devices at a given time (for example, in a given slot or a given symbol).

As shown in FIG. 4, examples 400 and 405 show examples of in-band full-duplex (IBFD) communication. In IBFD, a UE may transmit an uplink communication to a base station and receive a downlink communication from the base station on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of SBFD communication, which may also be referred to as “sub-band frequency division duplex (SBFDD)” or “flexible duplex.” In SBFD, a network node may transmit a downlink communication and receive an uplink communication at the same time, but on different frequency resources. For example, the different frequency resources may be sub-bands of a frequency band, such as a time division duplexing band. In such examples, the frequency resources used for downlink communication (for example, the downlink sub-band) may be separated from the frequency resources used for uplink communication (for example, the uplink sub-band), in the frequency domain, by a guard band.

As indicated above, FIG. 4 is provided as an example. Other examples may differ from what is described with respect to FIG. 4.

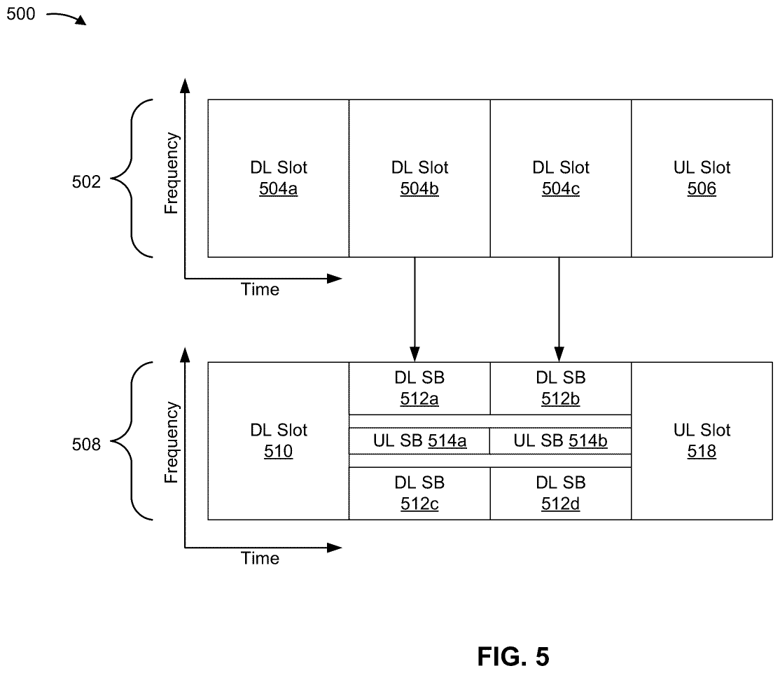

FIG. 5 is a diagram illustrating an example 500 of SBFD activation, in accordance with the present disclosure. As shown in FIG. 5, example 500 includes a first configuration 502. In some examples, the first configuration 502 may indicate a first slot format pattern (sometimes called a TDD pattern) associated with an HD mode or an FD mode. The first slot format pattern may include a quantity of downlink slots (for example, three downlink slots 504a, 504b, and 504c, as shown), a quantity of flexible slots (not shown), and/or a quantity of uplink slots (for example, one uplink slot 506, as shown). The first slot format pattern may repeat over time. In some examples, a network node (for example, network node 110) may indicate the first slot format pattern to a UE (for example, UE 120) using one or more slot format indicators. A slot format indicator, for a slot, may indicate whether that slot is an uplink slot, a downlink slot, or a flexible slot, among other examples.

A network node may instruct (for example, using an indication, such as an RRC message, a MAC-CE, or DCI) a UE to switch from the first configuration 502 to a second configuration 508. As an alternative, the UE may indicate to the network node that the UE is switching from the first configuration 502 to the second configuration 508. The second configuration 508 may indicate a second slot format pattern that repeats over time, similar to the first slot format pattern. In any of the examples described above, the UE may switch from the first configuration 502 to the second configuration 508 during a time period (for example, a quantity of symbols and/or an amount of time (for example, in ms)) based on or otherwise associated with an indication received from the network node (for example, before switching back to the first configuration 502). During that time period, the UE may communicate using the second slot format pattern, and then may revert to using the first slot format pattern after the end of the time period. The time period may be indicated by the network node (for example, in the instruction to switch from the first configuration 502 to the second configuration 508, as described above) and/or based on or otherwise associated with a programmed and/or otherwise preconfigured rule. For example, the rule may be based on or otherwise associated with a table (for example, defined in 3GPP specifications and/or another wireless communication standard) that associates different sub-carrier spacings (SCSs) and/or numerologies (for example, represented by μ and associated with corresponding SCSs) with corresponding time periods for switching configurations.

In example 500, the second slot format pattern includes a downlink slot 510, two SBFD slots in place of what were downlink slots in the first slot format pattern, and an uplink slot 518. In example 500, each SBFD slot includes at least one downlink sub-band (SB) (for example, DL SBs 512a, 512b, 512c, and 512d, as shown) and at least one uplink SB (for example, UL SBs 514a and 514b, as shown). Accordingly, the UE may operate using the second slot format pattern to transmit an uplink communication in an earlier slot (for example, the second slot in sequence, shown as partial UL slot 514a), as compared to using the first slot format pattern (for example, the fourth slot in sequence, shown as UL slot 506). Other examples may include additional or alternative changes. For example, the second configuration 508 may indicate an SBFD slot in place of what was an uplink slot in the first configuration 502 (for example, UL slot 506). In another example, the second configuration 508 may indicate a downlink slot or an uplink slot in place of what was an SBFD slot in the first configuration 502 (not shown in FIG. 5). In yet another example, the second configuration 508 may indicate a downlink slot or an uplink slot in place of what was an uplink slot or a downlink slot, respectively, in the first configuration 502.

“SBFD slot” may refer to a slot in which an SBFD format is used. An SBFD slot may also be referred to as a “DL+UL slot” or a “D+U slot.” An SBFD format may include a slot format in which full-duplex communication is supported (for example, for both uplink and downlink communications), with one or more frequencies used for an uplink SB of the slot being separated from one or more frequencies used for a downlink SB of the slot by a guard band. In some examples, the SBFD format may include a single uplink SB and a single downlink SB separated by a guard band. In some examples, the SBFD format may include multiple downlink SBs and a single uplink SB that is separated from the multiple downlink SBs by respective guard bands (for example, as shown in FIG. 5). In some examples, an SBFD format may include multiple uplink SBs and a single downlink SB that is separated from the multiple uplink SBs by respective guard bands. In some examples, the SBFD format may include multiple uplink SBs and multiple downlink SBs, where each uplink SB is separated from a downlink SB by a guard band. In some examples, operating using an SBFD mode may include activating or using an FD mode in one or more slots based on or otherwise associated with the one or more slots having the SBFD format. A slot may support the SBFD mode if an UL BWP and a DL BWP are permitted to be or are simultaneously active in the slot in an SBFD fashion (for example, with guard band separation). “SBFD symbol” may refer to a symbol (e.g., an OFDM symbol) in which an SBFD format is used. An SBFD symbol may also be referred to as a “DL+UL symbol” or a “D+U symbol.” In some examples, SBFD operation may be activated at a slot level, and an SBFD symbol may be a symbol of an SBFD slot. In some examples, SBFD operation may be activated at a symbol level, and a slot may include one or more SBFD symbols and one or more non-SBFD symbols.

As indicated above, FIG. 5 is provided as an example. Other examples may differ from what is described with respect to FIG. 5.

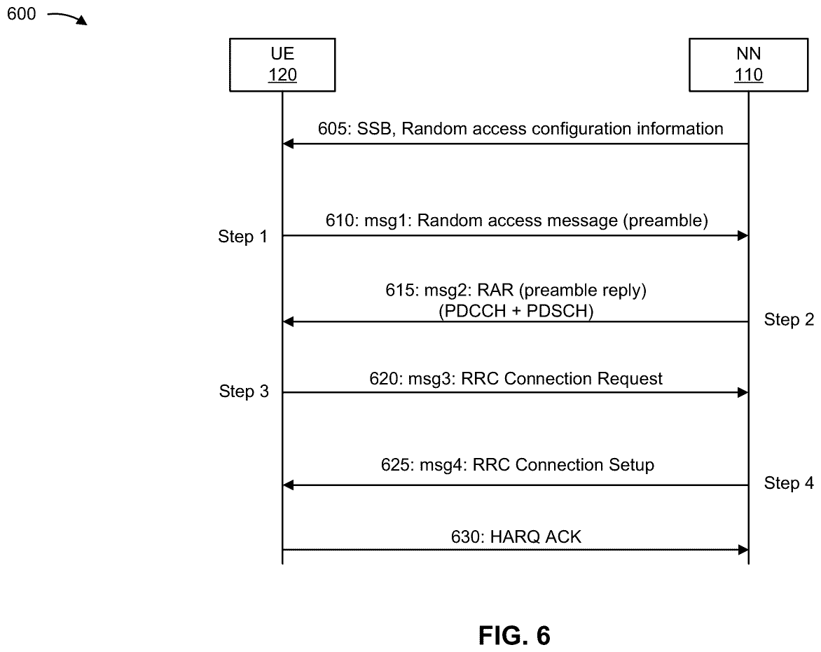

FIG. 6 is a diagram illustrating an example 600 of a four-step random access procedure, in accordance with the present disclosure. As shown in FIG. 6, a network node 110 and a UE 120 may communicate with one another to perform the four-step random access procedure.

As shown by reference number 605, the network node 110 may transmit, and the UE 120 may receive, one or more SSBs and random access configuration information. In some examples, the network node 110 may transmit multiple SSBs in different beam directions, and the UE 120 may detect (e.g., receive) one or more of the SSBs transmitted by the network node 110. The UE may measure the signal strength of each detected SSB and select an SSB (e.g., an SSB detected with the strongest signal strength). In some examples, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving random access response (RAR). For example, the random access configuration may include parameters for mapping SSBs indexes to ROs for transmitting the RAM.

As shown by reference number 610, the UE 120 may transmit a RAM, which may include a preamble (sometimes referred to as a random access preamble, a PRACH preamble, a RACH preamble, or a RAM preamble). The message that includes the preamble may be referred to as a PRACH transmission, a message 1, msg1, msg-1,MSG1, a first message, or an initial message in a four-step random access procedure. The RAM may include a random access preamble identifier. In some examples, the UE 120 may transmit the RAM in an RO associated with the SSB index of the SSB selected by the UE 120 based at least in part on the parameters, included in the ransom access configuration, for mapping the SSBs indexes to ROs. In this way, the network node 110 may identify the SSB (e.g., and the corresponding beam direction) selected by the UE 120.

As shown by reference number 615, the network node 110 may transmit an RAR as a reply to the preamble. The message that includes the RAR may be referred to as message 2, msg2, msg-2, MSG2, or a second message in a four-step random access procedure. In some examples, the RAR may indicate the detected random access preamble identifier (e.g., received from the UE 120 in msg1). Additionally, or alternatively, the RAR may indicate a resource allocation to be used by the UE 120 to transmit message 3 (msg3).

In some examples, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 620, the UE 120 may transmit an RRC connection request message. The RRC connection request message may be referred to as message 3, msg3, msg-3, MSG3, or a third message of a four-step random access procedure. In some examples, the RRC connection request may include a hybrid automatic repeat request (HARQ) identifier, UCI, and/or a HARQ communication (e.g., an RRC connection request).

As shown by reference number 625, the network node 110 may transmit an RRC connection setup message. The RRC connection setup message may be referred to as message 4, msg4, msg-4, MSG4, or a fourth message of a four-step random access procedure. In some examples, the RRC connection setup message may include the detected HARQ identifier, a timing advance value, and/or contention resolution information. As shown by reference number 630, if the UE 120 successfully receives the RRC connection setup message, the UE 120 may transmit a HARQ acknowledgement (ACK).

As indicated above, FIG. 6 is provided as an example. Other examples may differ from what is described with regard to FIG. 6.

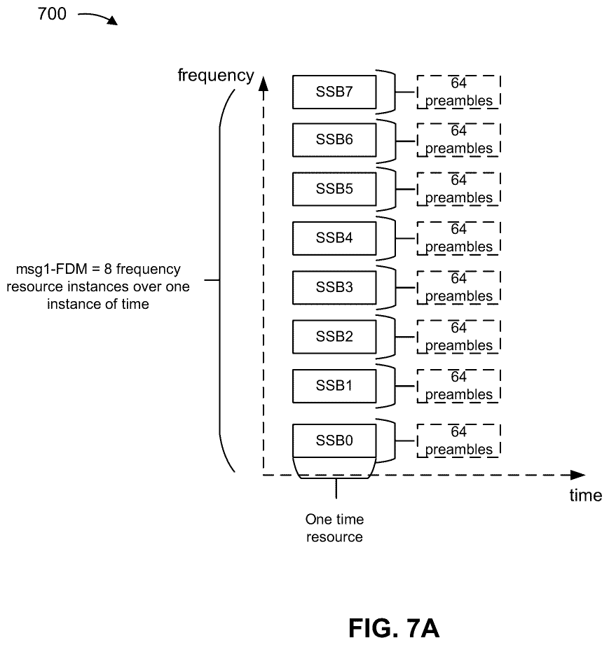

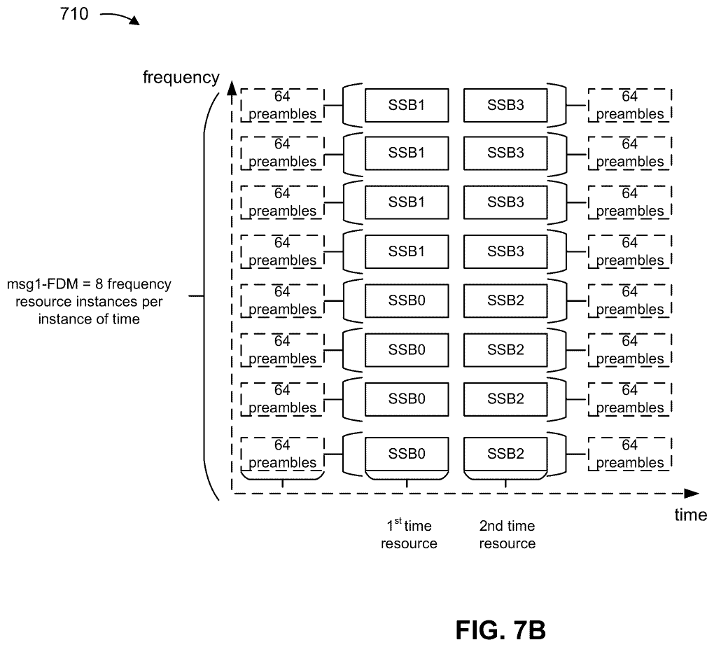

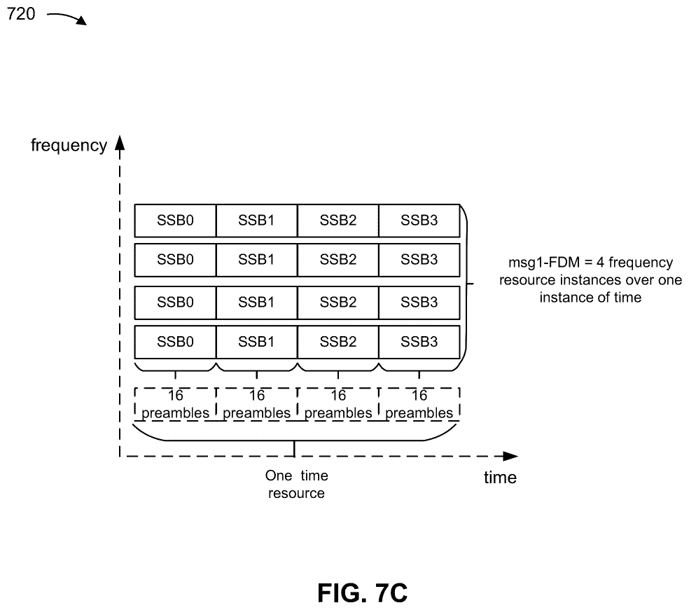

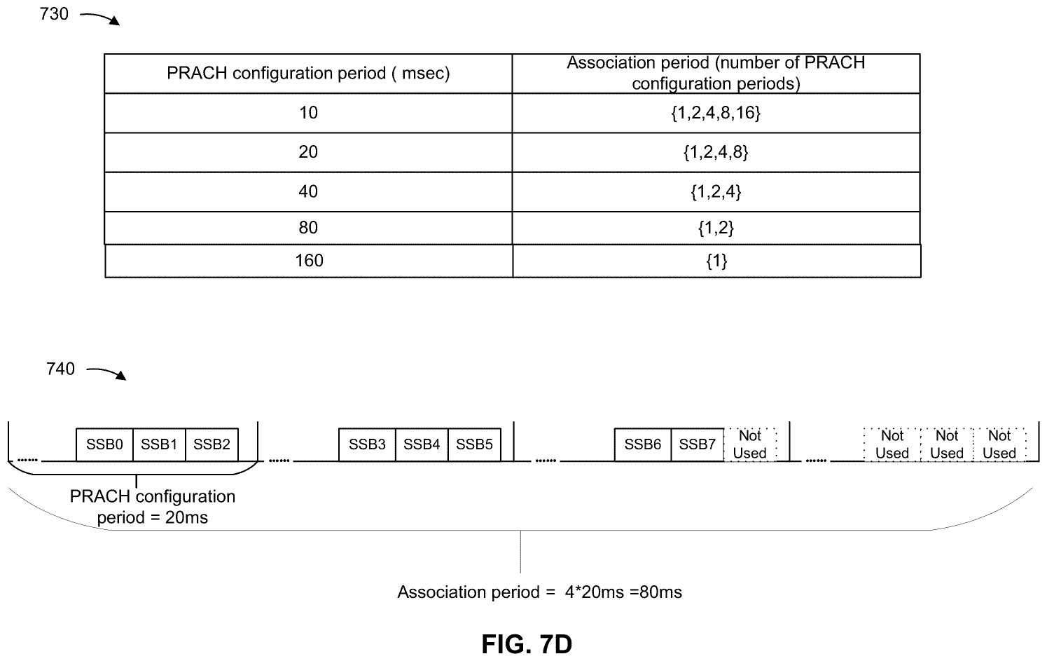

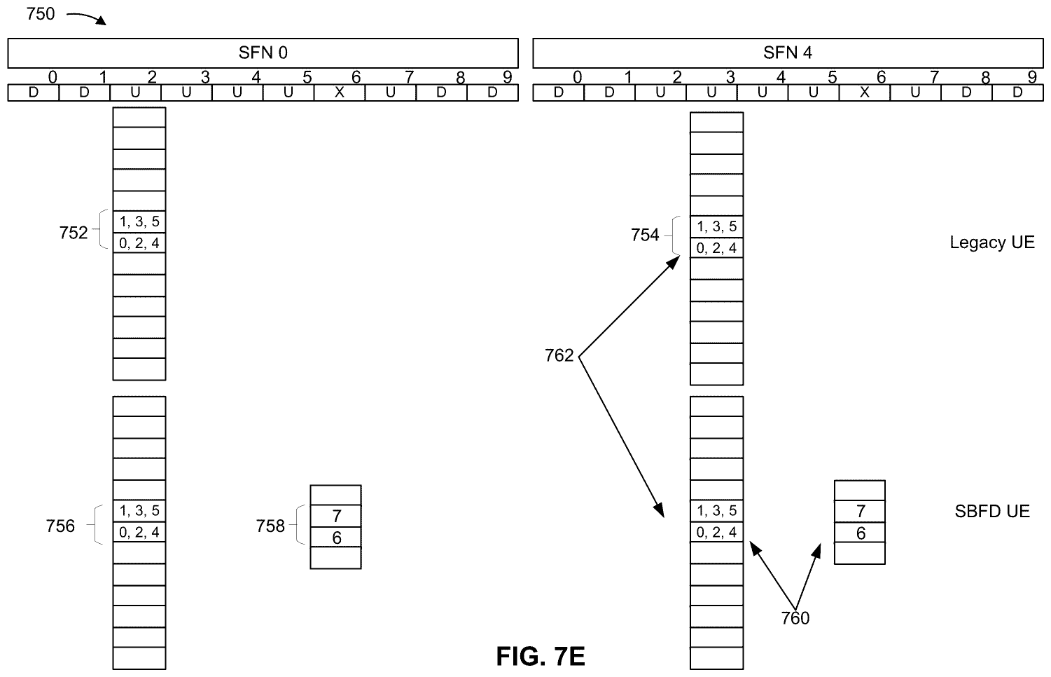

FIGS. 7A-7E are diagrams illustrating examples of mapping SSBs to ROs, in accordance with the present disclosure.

An RO, which may also be referred to as a PRACH occasion, is an area (e.g., resources) specified in the time and frequency domains that is available for the reception of a PRACH preamble by the network node. That is, ROs are time and frequency resources in which a UE may transmit a PRACH transmission (e.g., msg1) including a PRACH preamble. In LTE, there is only one RACH occasion specified by an RRC message (e.g., SIB type 2 (SIB2)) for all possible RACH preambles. In NR, different SSBs transmitted by a network node are associated with different beams, and a UE may select a certain beam/SSB (e.g., based on signal strength measurements of SSBs detected by the UE) and transmit a PRACH transmission (e.g., msg1) using that beam. In order for the network node to determine which beam (e.g., which SSB) the UE has selected, RRC parameters (e.g., indicated in SIB1) may define a specific mapping between the SSBs and corresponding ROs (e.g., in accordance with a wireless communication standard, such as 3GPP). The UE may transmit the PRACH transmission in an RO associated with the selected SSB. Accordingly, by detecting which RO the UE uses to transmit the PRACH transmission, the network node may determine which SSB/beam is selected by the UE.

The RRC parameters that define the mapping between the SSBs and the ROs may include msg1-FDM (or msgARO-FDM in a case in which a two-step RACH procedure is configured) and ssb-perRACH-OccasionAndCB-PreamblesPerSSB. msg1-FDM indicates a number of PRACH transmission occasions (e.g., ROs) frequency division multiplexed (FDM-ed) in one time instance. That is, msg1-FDM (or msgARO-FDM) specifies how many ROs can be allocated in the frequency domain (at the same location in the time domain). ssb-perRACH-OccasionAndCB-PreamblesPerSSB specifies how many SSBs can be mapped to one RO and how many preamble indexes can be mapped to a single SSB. ssb-perRACH-OccasionAndCB-PreamblesPerSSB may indicate a first value (ssb-perRACH-Occasion) that conveys information about the number of SSBs per RO. The first value (ssb-perRACH-Occasion) may be a choice of ⅛, ¼, ½, 1, 2, 4, 8, or 16. For example, a value of ⅛ corresponds to one SSB associated with eight ROs, a value of ¼ corresponds to one SSB associated with 4 ROs, and so on. ssb-perRACH-OccasionAndCB-PreamblesPerSSB may also indicate a second value (CB-PreamblesPerSSB) that indicates the number of contention-based preambles per SSB. The second value (CB-PreamblesPerSSB) may be selected from an enumerated set of values when the first value (ssb-perRACH-Occasion) is ⅛, ¼, ½, 1, or 2. In this case, a value of n4 corresponds to four contention-based preambles for SSB, a value of n8 corresponds to eight contention-based preambles per SSB, and so on. The second value (CB-PreamblesPerSSB) may be an integer value when the first value (ssb-perRACH-Occasion) is 4, 8, or 16. The total number of contention-based preambles in an RO may be given by CB-PreamblesPerSSB*max (1, ssb-perRACH-Occasion).

In some examples, the parameters (e.g., msg1-FDM and ssb-perRACH-OccasionAndCB-PreamblesPerSSB) that define the mapping between the SSBs and the ROs may be indicated in SIB1. For example, SIB1 may include a RACH-ConfigGeneric information element (IE) and a RACH-ConfigCommon IE. RACH-ConfigGeneric may indicate msg1-FDM, and RACH-ConfigCommon IE may indicate ssb-perRACH-OccasionAndCB-PreamblesPerSSB. The overall mapping logic (e.g., as described in 3GPP TS 38.213, section 8.1) for mapping the SSBs to the ROs may be as follows: first, in increasing order of preamble indexes within a single PRACH occasion (e.g., RO); second, in increasing order of frequency resource indexes for frequency multiplexed PRACH occasions (e.g., ROs); third, in increasing order of time resource indexes for time multiplexed PRACH occasions within a PRACH slot; and fourth in increasing order of indexes for PRACH slots.

FIGS. 7A, 7B, and 7C shows examples 700, 710, and 720 of mapping SSBs to ROs. In example 700 of FIG. 7A, msg1-FDM=8, the number of SSBs=8 (SSB0-SSB7), and ssb-perRACH-OccasionAndCB-PreamblesPerSSB=1, n64. Accordingly, as shown in example 700, ROs are mapped to eight frequency resources multiplexed in one time resource (e.g., msg1-FDM=8), and each SSB of the eight SSBs (SSB0-SSB7) is mapped to a respective RO (e.g., ssb-perRACH-Occasion=1) with 64 contention-based preambles mapped to each SSB (e.g., CB-PreamblesPerSSB=64). The time resource may be one or more symbols. For example, the number of symbols for the time resource may be based at least in part on a preamble format. In example 700, the network node may be able to implicitly understand (e.g., determine) the SSB selected by the UE based on the frequency location of the RO used to transmit the PRACH transmission (e.g., msg1).

In example 710 of FIG. 7B, msg1-FDM=8, the number of SSBs=4 (SSB0-SSB3), and ssb-perRACH-OccasionAndCB-PreamblesPerSSB=¼, n64. Accordingly, as shown in example 710, ROs are mapped to eight frequency resources multiplexed per time resource (e.g., msg1-FDM=8), and each SSB of the four SSBs (SSB0-SSB3) is mapped to four ROs (e.g., ssb-perRACH-Occasion=¼). In particular, SSB0 is mapped to four ROs in a first time resource, SSB1 is mapped to four ROs in the first time resource, SSB2 is mapped to four ROs in a second time resource, and SSB3 is mapped to four ROs in the second time resource. In example 710, 64 contention-based preambles are mapped to each SSB (e.g., CB-PreamblesPerSSB=64) in each RO. The first and second time resources may each be one or more symbols. For example, the number of symbols for the first and second time resources may be based at least in part on a preamble format. In example 710, the network node may be able to implicitly understand (e.g., determine) the SSB selected by the UE based on the frequency location and the time location of the RO used to transmit the PRACH transmission (e.g., msg1).

In example 720 of FIG. 7C, msg1-FDM=4, the number of SSBs=4 (SSB0-SSB3), and ssb-perRACH-OccasionAndCB-PreamblesPerSSB=4, 16. Accordingly, as shown in example 720, ROs are mapped to four frequency resources multiplexed in one time resource (e.g., msg1-FDM=4), and all four SSBs (SSB0-SSB3) are mapped to each RO (e.g., ssb-perRACH-Occasion=4). In example 720, 16 contention-based preambles are mapped to each SSB (e.g., CB-PreamblesPerSSB=64) for a total of 64 preambles mapped to each RO (e.g., 16 preambles each for the four SSBs mapped to each RO). The time resource may be one or more symbols. For example, the number of symbols for the time resource may be based at least in part on a preamble format. In example 720, the network node may be able to implicitly understand (e.g., determine) the SSB selected by the UE based on the preamble included in the PRACH transmission (e.g., msg1).

FIG. 7D shows an example table 730 for determining an SSB to RO association period. The association period is a time period associated with mapping all SSBs in a set of SSBs to at least one RO. For example, an association period, starting from a first frame (frame 0), for mapping SSB indexes to ROs may be the smallest value (for the number of PRACH configuration periods) determined based on the PRACH configuration period according to the table 730 shown in FIG. 7D, such that every SSB index is mapped to at least RO within the association period.

FIG. 7D also shows an example 740 of an association period for mapping SSBs to ROs. As shown in example 740, the PRACH configuration period is 20 ms. For example, the PRACH configuration period may be a time period associated with a single PRACH slot. As further shown in example 740, the number of SSBs (N_{Tx}^{SSB}) is eight (SSB0-SSB7), and the number of SSBs per RO (ssb-perRACH-Occasion) is one. In example 740, three ROs can be mapped to each PRACH slot. For example, ROs for transmitting three A2 format preambles may be mapped to each PRACH slot (e.g., an A2/A2/A2 preamble format may be associated with each PRACH slot). In this case, each RO may be mapped to four symbols in the PRACH slot. In example 740, the association period is 4×20 ms=80 ms. The association period of 80 ms corresponds to four PRACH slots. As shown in example 740, SSB0, SSB1, and SSB2 are mapped to the first PRACH slot of the association period, SSB3, SSB4, and SSB5 are mapped to the second PRACH slot of the association period, and SSB6 and SSB7 are mapped to the third PRACH slot of the association period. As further shown in example 740, the third RO in the third PRACH slot in the association period and the three ROs in the fourth slot in the association period are not used (e.g., not mapped to SSBs). In some examples, the association period for mapping SSBs to ROs may be reduced if ROs are FDM-ed. In some examples, if ROs are restricted to SBFD slots (e.g., for SBFD-aware UEs), then the association period will be different from the association period associated with ROs mapped to UL slots.

In some examples, random access preambles (e.g., PRACH preambles) may only be transmitted in frequency resources given by the higher-layer parameter msg1-FrequencyStart (or msgA-RO-FrequencyStart if configured). msg1-FrequencyStart (or msgA-RO-FrequencyStart if configured) indicates a lowest frequency for PRACH transmission (e.g., an offset to the lowest frequency for PRACH transmission with respect to a first physical resource block (PRB)). For example, the PRACH frequency resources n_{RA}∈{0, 1, . . . , M−1}, where M equals the higher-layer parameter msg1-FDM (or msgARO-FDM if configured), may be numbered in increasing order in the initial uplink BWP during initial access, starting from the lowest frequency indicated by msg1-FrequencyStart (or msgA-RO-FrequencyStart if configured). Otherwise (e.g., in cases other than during initial access), the PRACH frequency resources nRA may be numbered in increasing order within the active uplink BWP, starting from the lowest frequency indicated by msg1-FrequencyStart (or msgA-RO-FrequencyStart if configured). In some aspects, the frequency domain allocation of PRACH resources for an SBFD slot (e.g., a D+U slot) may be different from the frequency domain allocation of PRACH resources in an UL slot to enable the ROs to be mapped within an UL SB of the SBFD slot, which may have a different bandwidth from the UL BWP of the UL slot.

For a type-1 random access procedure (e.g., the four-step random access procedure), ssb-perRACH-OccasionAndCB-PreamblesPerSSB may indicate, to a UE, a number N of SSB indexes associated with one PRACH occasion and a number R of contention-based preambles per SSB index per valid PRACH occasion (e.g., RO). If N<1, one SSB index is mapped to 1/N consecutive valid PRACH occasions (e.g., ROs), and R contention-based preambles with consecutive indexes associated with the SSB index per valid PRACH occasion start from preamble index 0. If N≥1, R contention-based preambles with consecutive indexes associated with the SSB index n, 0≤n≤N−1, per valid PRACH occasion start from preamble index n·N/N_{preamble}^{total}, where N_{preamble}^{total} is the total number of contention-based preambles (e.g., indicated by totalNumberOfRA-Preambles) for the type-1 random access procedure and is an integer multiple of N. As described above, SSB indexes (e.g., SSB indexes provided by ssb-PositionsInBurst in SIB1 or in ServingCellConfigCommon) may be mapped to valid PRACH occasions (e.g., ROs) in the following order: first, in increasing order of preamble indexes within a single PRACH occasion (e.g., RO); second, in increasing order of frequency resources for frequency multiplexed PRACH occasions (e.g., ROs); third, in increasing order of time resource indexes for time multiplexed PRACH occasions (e.g., ROs) within a PRACH slot; and fourth, in increasing order of indexes for PRACH slots.

In some examples, if SBFD-aware UEs map x SSBs to y ROs, and the y ROs are spread across SBFD slots (e.g., D+U slots) and UL slots within an association period, then there may be an ambiguity between the mapping of SSBs to ROs performed by legacy (e.g., non-SBFD-aware) UEs and the mapping of SSBs to ROs performed by SBFD-aware UEs in one or more UL slots. FIG. 7E shows an example 750 of mapping SBFDs to ROs by a legacy UE (e.g., a non-SBFD-aware UE) and an SBFD-aware UE (shown as “SBFD UE”). In example 750, the number of SSBs=8 (SSB0-SSB7), msg1-FDM=2, and ssb-perRACH-OccasionAndCB-PreamblesPerSSB=1, n64. In example 750, the PRACH slots may be repeated every fourth system frame number (SFN) (e.g., n_f mod 4=0), starting with SFN 0, in subframe numbers 2, 6, and 9. As shown in FIG. 7E, each frame (e.g., SFN 0 and SFN 4) includes 10 subframes (e.g., subframe 0-subframe 9) with a TDD pattern of DDUUUUXUDD, where “D” represents a DL subframe, “U” represent an UL subframe, and “X” represents a flexible subframe (e.g., an SBFD subframe or a D+U subframe). In some examples (e.g., for 15 kHz SCS), each subframe may equal one slot (e.g., 14 symbols). In some examples (e.g., for 30 kHz SCS), each subframe may equal two slots (e.g., 28 symbols). The UEs may map SSBs to valid ROs. For the legacy UE, the valid ROs are those that overlap with an UL slot (e.g., in an UL subframe if the UE is provided tdd-UL-DL-ConfigurationCommon). Accordingly, in example 750, the legacy UE may map SSBs to ROs in subframe 2 (e.g., an UL subframe), but the legacy UE may not map SSBs to ROs in subframe 6 (e.g., an SBFD subframe) or subframe 9 (e.g., a DL subframe). For the SBFD-aware UE, the valid ROs may be those that overlap with an UL slot (e.g., in an UL subframe) or an SBFD slot (e.g., in a flexible or SBFD subframe). Accordingly, in example 750, the SBFD-aware UE may map SSBs to ROs in subframe 2 (e.g., an UL subframe) and subframe 6 (e.g., an SBFD subframe), but the SBFD-aware UE may not map SSBs to ROs in subframe 9 (e.g., a DL subframe).

In example 750, each PRACH slot may allow three ROs in the time domain. For example, each RO may be associated with an A2 preamble format with a PRACH duration of four symbols, such that the three RO time resources (of 4 symbols each) are mapped to the 12 symbols (e.g., each of the first 12 symbols) in a PRACH slot. In the case in which each subframe includes two slots (e.g., for 30 kHz SCS), a PRACH slot may be the first slot in the subframe (e.g., the three RO time resources (of 4 symbols each) may be mapped to the first 12 symbols of the 28 symbols in the subframe).

As shown in FIG. 7E, and by reference number 752, the legacy UE may map SSB0, SSB1, SSB2, SSB3, SSB4, and SSB5 to ROs in a PRACH slot in subframe 2 of SFN 0. For example, two ROs may be FDM-ed (e.g., msg1-FDM=2) in each of the three time resources (of 4 symbols each), for a total of six ROs in the PRACH slot in subframe 2 of SFN 0. As shown by reference number 754, the legacy UE may map SSB6 and SSB7 to ROs in a PRACH slot (e.g., two ROs FDM-ed in a time resource) in subframe 2 of SFN 4. As shown by reference number 756, the SBFD-aware UE may map SSB0, SSB1, SSB2, SSB3, SSB4, and SSB5 to ROs in a PRACH slot in subframe 2 of SFN 0. As shown by reference number 758, the SBFD-aware UE may map SSB6 and SSB7 to ROs in a PRACH slot in subframe 6 (e.g., the SBFD subframe) of SFN 0. As shown by reference number 760, the SBFD-aware UE may repeat the mapping of SBFDs from SFN 0 in SFN 4 (e.g., in a next association period for the SBFD-aware UE). That is, the SBFD-aware UE may map SSB0, SSB1, SSB2, SSB3, SSB4, and SSB5 to ROs in a PRACH slot in subframe 2 of SFN 4, and the SBFD-aware UE may map SSB6 and SSB7 to ROs in a PRACH slot in subframe 6 of SFN 4.

As shown by reference number 762, there is ambiguity between the SSBs (e.g., SSB6 and SSB7) mapped by the legacy UE to ROs in an uplink slot in subframe 2 of SFN4 and the SSBs (e.g., SSBO and SSB1) mapped by the SBFD-aware UE to the same ROs (e.g., at the same time instance) in the uplink slot in subframe 2 of SFN 4. This ambiguity is created due to the SBFD-aware UE and the legacy UE computing different mappings from the same random access resource configuration. As a result of this ambiguity, if the network node receives, from a UE, a PRACH transmission in an RO in the uplink slot in subframe 2 of SFN 4, the network node may not be able to determine the correct mapping to the SSB selected by the UE.

In some examples, legacy UEs and SBFD-aware UEs can share the same random access configuration if all of the SSBs can be mapped to ROs within the same slot. In this case, the UEs can follow different power control equations, configured by the network node, for transmitting the PRACH transmission in an UL slot or in an SBFD slot. However, as shown in FIG. 7E, in a case in which an SBFD-aware UE maps SSBs to ROs spread across UL and SBFD (e.g., D+U) slots, the SBFD-aware UE and a legacy UE may map different SSBs to the same RO, which may make it difficult for a network node to correctly identify the SSB associated with a PRACH transmission received in that RO.

As indicated above, FIGS. 7A-7E are provided as examples. Other examples may differ from what is described with respect to FIGS. 7A-7E.

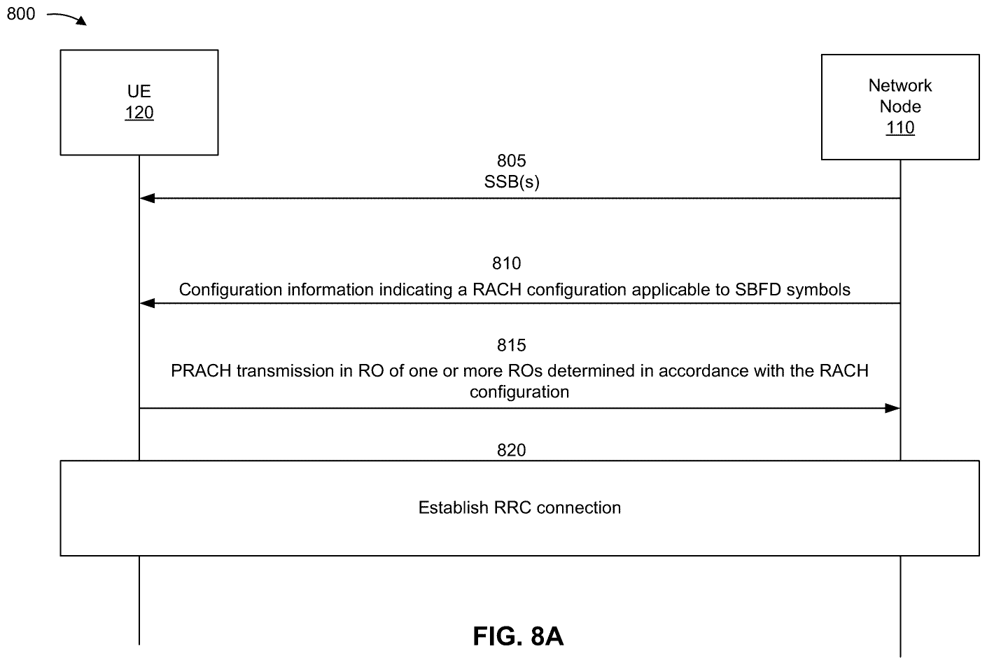

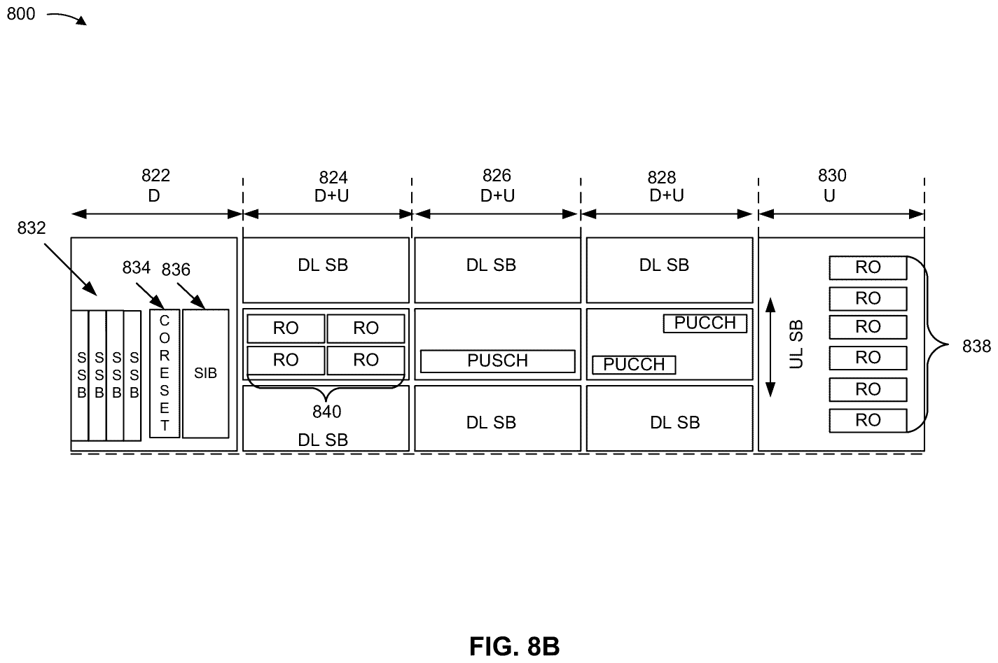

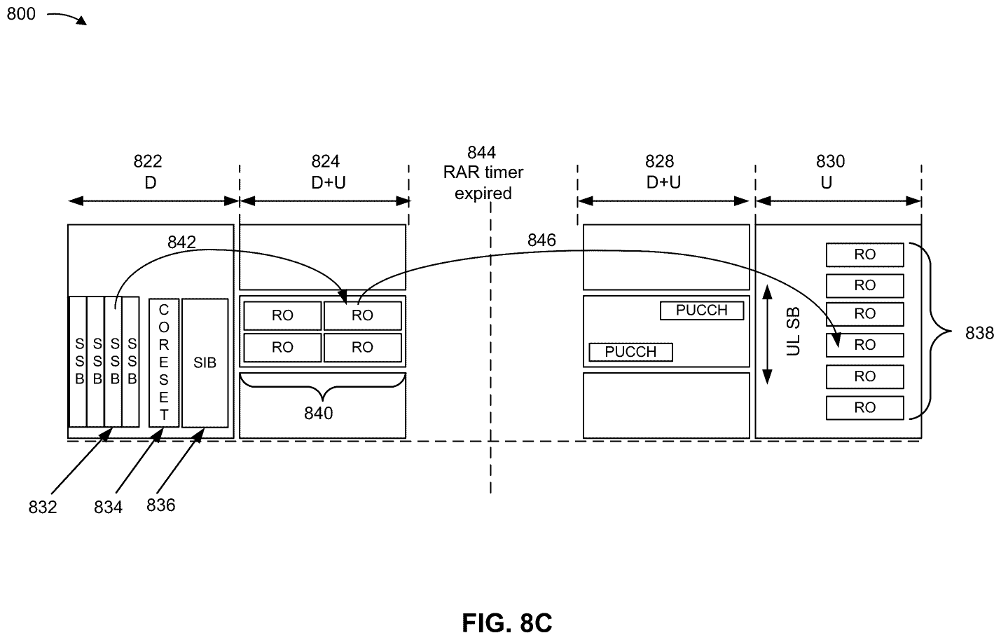

FIGS. 8A-8C are diagrams illustrating an example 800 associated with SBFD PRACH transmission, in accordance with the present disclosure. As shown in FIG. 8A, example 800 includes communication between a network node 110 and a UE 120. In some aspects, the network node 110 and the UE 120 may be included in a wireless communication network, such as wireless communication network 100. In some aspects, the UE 120 may be an SBFD-aware UE (e.g., an SBFD-capable UE or an SBFD UE). In some aspects, the UE 120 may be a non-SBFD-aware UE (e.g., a legacy UE).

As shown in FIG. 8A, and by reference number 805, the network node 110 may transmit, and the UE 120 may receive, one or more SSBs. In some aspects, the network node 110 may transmit (e.g., broadcast) multiple SSBs using different beams. The SSBs may be associated with respective SSB indexes. The UE 120 may detect (e.g., receive) one or more of the SSBs transmitted by the network node 110. The UE 120 may measure a signal strength of each detected SSB, and the UE 120 may select an SSB based at least in part on the signal strength measurements of the one or more detected SSBs. For example, the UE 120 may select a strongest SSB (e.g., an SSB with the strongest signal strength) of the one or more detected SSBs.

As further shown in FIG. 8A, and by reference number 810, the network node 110 may transmit, and the UE 120 may receive, configuration information indicating a RACH configuration that is applicable to SBFD symbols. The RACH configuration that is applicable to SBFD symbols may allow, permit, or enable the UE 120 (e.g., an SBFD-aware UE) to use SBFD symbols for PRACH transmission. In some aspects, the RACH configuration that is applicable to SBFD symbols may only be applicable to SBFD symbols. That is, the RACH configuration that is applicable to SBFD symbols may only be used to map SSBs to ROs in SBFD symbols (e.g., in an uplink sub-band). In this case, ROs determined from the RACH configuration applicable to SBFD symbols may be considered valid ROs (e.g., for PRACH transmission) only if they overlap with an SBFD slot. In some other aspects, the RACH configuration that is applicable to SBFD symbols may also be applicable to uplink symbols. That is the RACH configuration that is applicable to SBFD symbols may be used to map SSBs to ROs in SBFD symbols (e.g., in the uplink sub-band) and in uplink symbols. In this case, ROs determine from the RACH configuration applicable to SBFD symbols may be considered valid (e.g., for PRACH transmission) if they overlap with an SBFD slot or an uplink slot.

In some aspects, all or a portion of the configuration information indicating the RACH configuration that is applicable to SBFD symbols may be included in a SIB (e.g., SIBx). For example, the RACH configuration that is applicable to SBFD symbols may be indicated in a SIB (e.g., SIBx) that is broadcast by the network node 110 and received by the UE 120 (e.g., when the UE 120 is operating in an RRC idle or inactive state). In some examples, all or a portion of the configuration information indicating the RACH configuration that is applicable to SBFD symbols may be included in SIB1. Additionally, or alternatively, all or part of the configuration information indicating the RACH configuration that is applicable to SBFD symbols may be included in one or more other SIBs and/or one or more other RRC messages, such as in a dedicated or common RRC configuration (e.g., when the UE 120 is operating in an RRC connected state).

In some aspects, the configuration information may indicate a first RACH configuration for uplink symbols and a second RACH configuration for SBFD symbols. In some aspects, all or a portion of the configuration information indicating the first RACH configuration and the second RACH configuration may be included in a SIB (e.g., SIBx). For example, the first RACH configuration and the second RACH configuration may be indicated in a SIB (e.g., SIBx) that is broadcast by the network node 110 and received by the UE 120 (e.g., when the UE 120 is operating in an RRC idle or inactive state). In some examples, all or a portion of the configuration information indicating the first RACH configuration and the second RACH configuration may be included in SIB1. Additionally, or alternatively, all or part of the configuration information indicating the first RACH configuration and the second RACH configuration may be included in one or more other SIBs and/or one or more other RRC messages, such as in a dedicated or common RRC configuration (e.g., when the UE 120 is operating in an RRC connected state).

In some aspects, the first RACH configuration and the second RACH configuration may indicate separate mappings of SSBs to ROs in uplink symbols and SBFD symbols, respectively. For example, the first RACH configuration may indicate a first mapping of SSBs to ROs in uplink symbols, and the second RACH configuration may indicate a second mapping of SSBs to ROs in uplink sub-bands of SBFD symbols. In this case, the first mapping of SSBs to ROs in uplink symbols may be independent with respect to the second mapping of SSBs to ROs in uplink sub-bands of SBFD symbols. In some aspects, the first RACH configuration and the second RACH configuration may indicate different first frequency division multiplexing (FDM) parameters (e.g., different msg1-FDM or msgARO-FDM parameters) and/or different starting frequency parameters (e.g., different msg1-FrequencyStart or msgA-RO-FrequencyStart parameters). For example, the first RACH configuration may indicate a first FDM parameter (e.g., msg1-FDM or msgARO-FDM) and a first starting frequency parameter (e.g., msg1-FrequencyStart or msgA-RO-FrequencyStart) for ROs in uplink symbols, and the second RACH configuration may indicate a second FDM parameter (e.g., msg1-FDM or msgARO-FDM) and a second starting frequency parameter (e.g., msg1-FrequencyStart or msgA-RO-FrequencyStart) for ROs in SBFD symbols. The first FDM parameter may indicate a number of ROs FDM-ed in one time location in uplink symbols, and the first starting frequency parameter may indicate a lowest frequency for ROs in uplink symbols. The second FDM parameter may indicate a number of ROs FDM-ed in one time location in SBFD symbols, and the second starting frequency parameter may indicate a lowest frequency for ROs in SBFD symbols. In some aspects, the second FDM parameter and the second starting frequency parameter may be set such that the ROs in the SBFD symbols are contained within an uplink sub-band in the SBFD symbols. Additionally, or alternatively, the first RACH configuration and the second RACH configuration may separately indicate one or more other parameters associated with PRACH transmission, such as separate ssb-perRACH-OccasionAndCB-PreamblesPerSSB parameters, separate power ramping parameters, and/or separate target receive power parameters, among other examples.

In some aspects, the configuration information may include a generic RACH configuration IE (e.g., RACH-ConfigGeneric) that indicates global RACH parameters, and a separate additional RACH configuration IE associated with SBFD symbols (e.g., RACH-ConfigCommon for SBFD symbols) that indicates SBFD RACH parameters. In this case, the additional RACH configuration IE associated with SBFD symbols (e.g., RACH-ConfigCommon for SBFD symbols) may include one or more SBFD RACH parameters that override (or overwrite) one or more of the global RACH parameters (indicated in RACH-ConfigGeneric) for SBFD symbols. For example, RACH-ConfigGeneric may indicate a global (or first) FDM parameter (e.g., msg1-FDM) and a global (or first) starting frequency parameter (e.g., msg1-FrequencyStart) that are set such that ROs are contained in an uplink BWP associated with uplink symbols, and RACH-ConfigCommon for SBFD symbols may indicate an SBFD-specific (or second) FDM parameter and/or an SBFD-specific (or second) starting frequency parameter that overrides the global (or first) FDM and/or starting frequency parameters for SBFD symbols, such that ROs in SBFD symbols are contained in the uplink sub-band. Additionally, or alternatively, RACH-ConfigCommon for SBFD symbols may indicate other SBSD-specific parameters, such as an SBFD-specific (or second) power ramping parameter that overrides a global (or first) power ramping parameter (indicated in RACH-ConfigGeneric) for SBFD symbols, and/or an SBFD-specific (or second) target receive power parameter that overrides a global (or first) target receive power parameter (indicated in RACH-ConfigGeneric) for SBFD symbols. In such examples, the second RACH configuration may be indicated by a combination of RACH-ConfigGeneric and RACH-ConfigCommon for SBFD symbols. In such examples, the configuration information may also include another additional RACH configuration IE associated with uplink symbols (e.g., RACH-ConfigCommon), which may be the same as or similar to a legacy RACH-ConfigCommon IE. In this case, the first RACH configuration may be indicated by a combination of RACH-ConfigGeneric and RACH-ConfigCommon (e.g., the additional RACH configuration IE for uplink symbols). In some aspects, the generic RACH configuration IE (e.g., RACH-ConfigGeneric), the additional RACH configuration IE associated with SBFD symbols (e.g., RACH-ConfigCommon for SBFD symbols), and the additional RACH configuration IE associated with uplink symbols (e.g., RACH-ConfigCommon) may be included in SIB1.

In some aspects, the configuration information may include a separate generic RACH configuration IE (e.g., RACH-ConfigGeneric) for SBFD PRACH transmission. For example, the configuration information may include a first generic RACH configuration IE (e.g., a first RACH-ConfigGeneric IE) associated with uplink symbols and a second generic RACH configuration IE (e.g., a first RACH-ConfigGeneric IE) associated with SBFD symbols. The first RACH-ConfigGeneric IE may indicate a first FDM parameter (e.g., a first msg1-FDM parameter) and a first starting frequency parameter (e.g., a first msg1-FrequencyStart parameter) for ROs in uplink symbols, and the second RACH-ConfigGeneric IE may indicate a second FDM parameter (e.g., a second msg1-FDM parameter) and a second starting frequency parameter (e.g., a second msg1-FrequencyStart parameter) for ROs in SBFD symbols. Additionally, or alternatively, the first RACH-ConfigGeneric IE may indicate one or more other parameters for PRACH transmission in uplink symbols, such as a first power ramping power parameter and/or a first target receive power parameter, among other examples, and the second RACH-ConfigGeneric IE may indicate one or more other parameters for PRACH transmission in SBFD symbols, such as a second power ramping power parameter and/or a second target receive power parameter, among other examples.

In some aspects, the first RACH configuration may be associated with a first PRACH configuration index, and the second RACH configuration may be associated with a second PRACH configuration index. In such examples, the first RACH configuration may indicate the first PRACH configuration index, and the second RACH configuration may indicate the second RACH configuration index. For example, in a case in which the configuration information includes the first RACH-ConfigGeneric IE for uplink symbols and the second RACH-ConfigGeneric IE for SBFD symbols, the first RACH-ConfigGeneric IE may indicate the first PRACH configuration index, and the second RACH-ConfigGeneric IE may indicate the second PRACH configuration index.

As shown in FIG. 8B, a TDD pattern may include a downlink (D) slot 822, followed by three SBFD (D+U) slots 824, 826, and 828, followed by an uplink (U) slot 830. The network node 110 may transmit (e.g., broadcast) SSBs 832 in the downlink slot 822, and the UE 120 may detect (e.g., receive) one or more of the SSBs 832. A master information block (MIB) included in an SSB 832 may configure a control resource set (CORESET) 834, and the UE 120 may receive a SIB 836 (e.g., SIB1) in the downlink slot 822 based at least in part on the CORESET 834. In some aspects, the SIB may include the first RACH configuration for uplink symbols and the second RACH configuration for SBFD symbols. The first RACH configuration may indicate a first mapping of SSBs to ROs in uplink symbols, and the second RACH configuration may indicate a second mapping of SSBs to ROs in SBFD symbols. For example, as shown in FIG. 8B, the SSBs 832 (e.g., the SSB indexes) may be mapped to a first set of ROs 838 in one or more uplink symbols in the uplink slot 830 in accordance with the first RACH configuration. As further shown in FIG. 8B, the SSBs 832 (e.g., the SSB indexes) may be mapped to a second set of ROs 840 in SBFD symbols in the SBFD slot 824 in accordance with the second RACH configuration. The second set of ROs 840 may be within the uplink sub-band in the SBFD symbols in SBFD slot 824. As shown in FIG. 8B, the SBFD slot 824 may be a PRACH slot that is available for ROs (e.g., the second set of ROs 840), and the SBFD slots 826 and 828 may not be available for ROs because the uplink sub-band in the SBFD slots 826 and 828 may be allocated for PUSCH and/or PUCCH communications.

In some aspects, an SBFD-aware UE (e.g., the UE 120) may have the option to select between the first RACH configuration and the second RACH configuration for transmitting a PRACH communication (e.g., a RAM, such as msg1 of a four-step random access procedure, or message A (msgA) of a two-step random access procedure). For example, the UE 120 may have the option to select between an RO from the first set of ROs 838 in the uplink symbols or an RO from the second set of ROs 840 in the SBFD symbols, as shown in FIG. 8B. In some examples, the network node 110 may signal (e.g., in the configuration information) one or more conditions in which SBFD-aware UEs are permitted to perform random access in SBFD symbols. In this case, the UE 120 (e.g., an SBFD-aware UE) may use an RO in one or more SBFD symbols (e.g., in the uplink sub-band) in connection with a determination that the one or more conditions are satisfied. For example, the configuration information may indicate (e.g., in the second RACH configuration associated with SBFD symbols) a threshold for downlink channel measurements to be satisfied. In this case, the UE 120 may determine whether one or more downlink channel measurements associated with one or more SSBs or one or more CSI-RSs satisfy the threshold, and the UE 120 may be permitted to use an RO in one or more SBFD symbols for transmitting the PRACH transmission, in connection with the one or more downlink channel measurements satisfying the threshold. For example, the one or more downlink channel measurements satisfying the threshold may indicate that the UE 120 is near a cell center, and therefore is a good candidate to perform random access using the SBFD symbols. As a result, inter-UE cross link interference (CLI) caused by using the uplink sub-band of the SBFD symbols for random access may be mitigated.

In some aspects, an SBFD-aware UE (e.g., the UE 120) may perform random access only in SBFD symbols. In some examples, in a case in which the UE 120 is an SBFD-aware UE, the UE 120 may be configured to first attempt to use ROs in SBFD symbols to transmit the PRACH transmission before using ROs in uplink symbols. For example, the UE 120 may first transmit a certain number (N) of transmissions (e.g., N retransmissions) using ROs in SBFD symbols prior to switching to ROs in uplink symbols (e.g., falling back to legacy RACH). In such examples, the UE 120 may fall back to legacy ROs in uplink symbols after N retransmissions of the PRACH transmission (e.g., msg1) (or after retransmitting the PRACH transmission over a certain time duration) in ROs in SBFD symbols. For example, the number (N) of transmissions (or the time duration) may be indicated in the configuration information.

In some aspects, in a case in which the UE 120 is operating in an RRC connected state, the UE 120 may receive at least a portion of the second RACH configuration for SBFD symbols via dedicated or common RRC configuration information elements. In some examples, the UE 120 may receive the configuration information indicating the second mapping of SSBs to ROs in SBFD symbols as discussed above (e.g., in SIB1), and the UE 120 may further receive, from the network node 110, a RACH-ConfigDedicated IE that includes an indication that the UE 120 is to use the resource pool associated with SBFD symbols (e.g., the ROs in SBFD symbols) first. In this case, the mechanism discussed above for falling back to the legacy ROs in the uplink symbols may be applied by the UE 120. In some other examples, SBFD-specific parameters for the mapping of SSBs to ROs in SBFD symbols may be indicated in a RACH-ConfigCommon IE (e.g., a RACH-ConfigCommon IE for SBFD symbols), and the UE 120 may further receive, from the network node 110, a RACH-ConfigDedicated IE that indicates a flag to enable or disable the SBFD-specific configuration (e.g., the SBFD-specific parameters) indicated in the RACH-ConfigCommon IE. In this case, if the flag indicates that the SBFD-specific configuration is enabled, the UE 120 may use ROs in SBFD symbols for the PRACH transmission. If the flag indicates that the SBFD-specific configuration is not enabled, the UE 120 may behave similar to a legacy UE and use ROs in uplink symbols for the PRACH transmission.

In some aspects, instead of receiving separate RACH configurations for uplink symbols and SBFD symbols, the UE 120 may receive, from the network node 110, configuration information including a single RACH configuration (e.g., including RACH-ConfigGeneric and RACH-ConfigCommon) and an indication of whether the UE 120 is to transmit PRACH transmissions in SBFD symbols. For example, in a case in which the UE 120 is an SBFD-aware UE, the configuration information may include an indication that the UE 120 is to transmit PRACH transmissions in SBFD symbols (e.g., an indication that the UE 120 is only permitted to transmit PRACH transmissions in SBFD symbols). In this case, the UE 120 may only use ROs in SBFD symbols for the PRACH transmission. For example, the UE 120 may map SSBs only to ROs in SBFD symbols in accordance with the RACH configuration. In a case in which the configuration information includes an indication that the UE 120 is not to transmit PRACH transmissions in SBFD symbols (e.g., an indication that the UE 120 is to transmit PRACH transmissions only in uplink symbols), the UE 120 may only use ROs in uplink symbols for the PRACH transmission. In this case, the UE 120 may map SSBs only to ROs in uplink symbols in accordance with the RACH configuration.

In some aspects, the configuration information may indicate separate RACH partitions for PRACH transmissions in SBFD symbols and for PRACH transmissions in uplink symbols. For example, the first RACH configuration may indicate a first set of PRACH preambles (e.g., contention-based preambles) for PRACH transmissions in ROs in uplink symbols, and the second RACH configuration may indicate a second set of PRACH preambles (e.g., contention-based preambles) for PRACH transmissions in SBFD symbols.

In some aspects, in addition to the first RACH configuration for uplink symbols and the second RACH configuration for SBFD symbols, the configuration information may also include a contention-free random access (CFRA) configuration associated with CFRA to be performed by the UE 120. For example, the network node 110 may transmit, and the UE 120 may receive, the CFRA configuration in a separate downlink transmission (e.g., in an RRC message, a MAC-CE, or DCI) from the transmission (e.g., SIB1) including the first RACH configuration and the second RACH configuration. The CFRA configuration may indicate a PRACH preamble to be transmitted by the UE 120 for CFRA. In some aspects, the CFRA configuration may be linked with a first PRACH resource set associated with the first RACH configuration (e.g., a set of ROs in uplink symbols) or a second PRACH resource set associated with the second RACH configuration (e.g., a set of ROs in SBFD symbols). For example, the CFRA configuration may include an indication pointing to (e.g., identifying) the first RACH configuration or the second RACH configuration. In some aspects, in a case in which the UE 120 is an SBFD-aware UE, the CFRA configuration may be an SBFD CFRA configuration that is linked to the second RACH configuration. For example, the CFRA configuration for SBFD UEs may always link to the RACH configuration for SBFD symbols (e.g., the second RACH configuration). In this case, the UE 120 may only use an RO in one or more SBFD symbols for the CFRA PRACH transmission. In some aspects, the CFRA configuration received by the UE 120 may be linked with either the first RACH configuration or the second RACH configuration. For example, an SBFD-aware UE may receive a CFRA configuration that is linked with the first RACH configuration for uplink symbols or the second RACH configuration for SBFD symbols. In this case, the UE 120 may use an RO in one or more uplink symbols for the CFRA PRACH transmission if the CFRA configuration is linked with the first RACH configuration, or the UE 120 may use an RO in one or more SBFD symbols for the CFRA PRACH transmission if the CFRA configuration is linked with the second RACH configuration. In some aspects, the CFRA may be linked with both the first RACH configuration and the second RACH configuration. In this case, the UE 120 may use either an RO in one or more uplink symbols (e.g., in accordance with the first RACH configuration) or an RO in one or more SBFD symbols (e.g., in accordance with the second RACH configuration) for the CFRA PRACH transmission.

Returning to FIG. 8A, as shown by reference number 815, the UE 120 may transmit, and the network node 110 may receive, a PRACH transmission in an RO of one or more ROs determined in accordance with the RACH configuration that is applicable to SBFD symbols. In some aspects, the one or more ROs determined (e.g., by the UE 120 and/or the network node 110) in accordance with the RACH configuration that is applicable to SBFD symbols may be in an uplink sub-band in one or more SBFD symbols. In some aspects, the one or more ROs determined (e.g., by the UE 120 and/or the network node 110) in accordance with the RACH configuration that is applicable to SBFD symbols may be in an uplink sub-band in one or more SBFD symbols and/or in one or more uplink symbols.

In some aspects, in a case in which the configuration information indicates the first RACH configuration for uplink symbols and the second RACH configuration for SBFD symbols, the UE 120 may transmit, and the network node 110 may receive, a PRACH transmission in an RO in one or more uplink symbols in accordance with the first RACH configuration, or in an RO in an uplink sub-band in one or more SBFD symbols in accordance with the second RACH configuration. In some aspects, the PRACH transmission may be a RAM, such as msg1 of a four-step random access procedure or msgA of a two-step random access procedure. In some aspects, the PRACH transmission may be associated with contention-based random access. In some aspects, the PRACH transmission may be associated with CFRA.

In some aspects, in a case in which the UE 120 is an SBFD-aware UE, the UE 120 may select between the first RACH configuration and the second RACH configuration, and the UE 120 may transmit the PRACH transmission in an RO in one or more uplink symbols or in an RO in one or more SBFD symbols based at least in part on the selection between the first RACH configuration and the second RACH configuration. For example, the UE 120 may transmit the PRACH transmission in an RO in one or more uplink symbols in accordance with the first RACH configuration in connection with selecting the first RACH configuration, or the UE 120 may transmit the PRACH transmission in an RO in the uplink sub-band in one or more SBFD symbols in accordance with the second RACH configuration in connection with selecting the second RACH configuration.

In some aspects, the UE 120 may select between the first RACH configuration and the second RACH configuration based on which RO, among a next valid RO associated with a detected SSB in accordance with the first RACH configuration and a next valid RO associated with the detected SSB in accordance with the second RACH configuration, occurs first in time after the detected SSB. The UE 120 may map SSBs to valid ROs associated with the first RACH configuration, and the UE 120 may map SSBs to valid ROs associated with the second RACH configuration. The valid ROs associated with the first RACH configuration may be ROs that overlap with an uplink slot. ROs associated with the second RACH configuration (e.g., for SBFD symbols) may only be valid ROs if they overlap with an SBFD slot. That is, ROs associated with the second RACH configuration that overlap with an SBFD slot are valid ROs (e.g., for transmission of the PRACH transmission), and ROs associated with the second RACH configuration that do not overlap with an SBFD slot are not valid ROs. For example, the UE 120 may ignore or discard ROs associated with the second RACH configuration that do not overlap with an SBFD slot. The UE 120 may determine (e.g., compute) a next valid RO associated with a selected SSB (e.g., a strongest SSB) based on the first RACH configuration (e.g., a next valid RO, in uplink symbols, that is associated with the selected SSB). The UE 120 may determine (e.g., compute) a next valid RO associated with the selected SSB based on the second RACH configuration (e.g., a next valid RO, in SBFD symbols, that is associated with the selected SSB). The UE 120 may then choose to transmit the RO, among the next valid RO in the uplink symbols and the next valid RO in the SBFD symbols, that falls closest in time to the selected SSB within the association period.

In some aspects, the UE 120 may select a different RACH configuration for an initial transmission of the PRACH transmission than for a retransmission of the RACH configuration. As shown in FIG. 8C, and by reference number 842, for an initial PRACH transmission, the UE 120 may select a next valid RO associated with a selected SSB 832 from the second set of ROs 840 in the SBFD slot 824 in accordance with the second RACH configuration. The UE 120 may transmit the initial PRACH transmission (e.g., a first transmission of the PRACH transmission) in the RO associated with the selected SSB 832 in the second set of ROs 840 in the uplink sub-band in one or more SBFD symbols in the SBFD slot 824. As shown by reference number 844, a timer associated with receiving the RAR may expire. As shown by reference number 846, for a retransmission of the PRACH transmission, the UE 120 may select a next valid RO associated with the selected SSB 832 from the first set of ROs 838 in the uplink slot 830. For example, the UE 120 may ignore the second RACH configuration associated with the SBFD symbols if there is no upcoming SBFD slot valid for the BWP. Accordingly, the UE 120 may choose to switch to an RO associated with the first RACH configuration for the retransmission of the PRACH communication. The UE 120 may transmit a retransmission (e.g., a second transmission) of the PRACH transmission in the RO associated with the selected SSB 832 in the first set of ROs 838 in one or more uplink symbols in the uplink slot 830.

In some aspects, in a case in which the UE 120 is an SBFD-aware UE, the UE 120 may determine whether one or more conditions (e.g., indicated in the configuration information) for performing random access in SBFD symbols are satisfied. In this case, the UE 120 may transmit the PRACH transmission in an RO in one or more SBFD symbols (e.g., in the uplink sub-band) in connection with a determination that the one or more conditions are satisfied. For example, the UE 120 may determine whether one or more downlink channel measurements associated with one or more SSBs satisfy a threshold (e.g., a threshold indicated in the second RACH configuration). Additionally, or alternatively, the UE 120 may determine whether one or more downlink channel measurements associated with one or more CSI-RSs satisfy a threshold (e.g., a threshold indicated in the second RACH configuration). In such examples, the UE 120 may transmit the PRACH transmission in an RO in the uplink sub-band in one or more SBFD symbols in connection with the one or more downlink channel measurements satisfying the threshold.

In some aspects, in a case in which the UE 120 is an SBFD-aware UE, the UE 120 may perform multiple transmissions of the PRACH transmission in ROs in SBFD symbols prior to falling back to transmitting the PRACH transmission in an RO in one or more uplink symbols. For example, the UE 120 may transmit multiple transmissions (e.g., multiple retransmissions) of the PRACH transmission in ROs in the uplink sub-band in SBFD symbols in accordance with the second RACH configuration. The UE 120 may then, in connection with the number of the multiple transmissions satisfying a threshold (e.g., N), transmit the PRACH transmission in an RO in one or more uplink symbols in accordance with the first RACH configuration. In some examples, when the UE 120 falls back to legacy RACH (e.g., transmitting the PRACH transmission in an RO in the uplink symbols), the UE 120 may start with a default preamble target Rx power (e.g., for legacy PRACH) or a different value of the preamble target Rx power.

In some aspects, in a case in which the UE 120 is an SBFD-aware UE, the UE 120 may transmit the PRACH transmission in an RO in the uplink sub-band in one or more SBFD symbols in accordance with the second RACH configuration based on the UE 120 being SBFD-aware. In some examples, an SBFD-aware UE may always transmit the PRACH transmission in an RO in one or mor SBFD symbols in accordance with the second RACH configuration (or in accordance with a single RACH configuration and an indication to transmit PRACH in SBFD symbols, as discussed above). In some aspects, in a case in which the UE 120 is a legacy UE (e.g., a non-SBFD-aware UE), the UE 120 may transmit the PRACH transmission in an RO in one or more uplink symbols in accordance with the first RACH configuration.

In some aspects, the first RACH configuration may indicate a first set of PRACH preambles for ROs in uplink symbols and the second RACH configuration indicates a second set of PRACH preambles for ROs in SBFD symbols. In such examples, in a case in which the UE 120 transmits the PRACH transmission in an RO in one or more uplink symbols in accordance with the first RACH configuration, the PRACH transmission may include a PRACH preamble of the first set of preambles. In a case in which the UE 120 transmits the PRACH transmission in an RO in the uplink sub-band in one or more SBFD symbols in accordance with the second RACH configuration, the PRACH transmission may include a PRACH preamble of the second set of preambles.

In some aspects, the PRACH transmission may be based at least in part on a CFRA configuration. For example, the PRACH transmission may include a PRACH preamble for CFRA that is indicated in the CFRA configuration. In some examples, the CFRA configuration may be an SBFD CFRA configuration that is linked with the second RACH configuration. In this case, the UE 120 may transmit the PRACH transmission in an RO in the uplink sub-band in one or more SBFD symbols in accordance with the second RACH configuration and the CFRA configuration. In some examples, the CFRA configuration may be linked with either the first RACH configuration or the second RACH configuration. In this case, based at least in part on the CFRA configuration being linked with the first RACH configuration, the UE 120 may transmit the RACH transmission in an RO in one or more uplink symbols in accordance with the first RACH configuration and the CFRA configuration. Alternatively, based at least in part on the CFRA configuration being linked with the second RACH configuration, the UE 120 may transmit the RACH transmission in an RO in the uplink sub-band in one or more SBFD symbols in accordance with the second RACH configuration and the CFRA configuration. In some examples, the CFRA configuration may be linked with both the first RACH configuration and the second RACH configuration. In this case, the UE 120 may select to transmit the PRACH transmission in an RO in one or more uplink symbols in accordance with the first RACH configuration and the CFRA configuration, or to transmit the PRACH transmission in an RO in the uplink sub-band in one or more SBFD symbols in accordance with the second RACH configuration and the CFRA configuration.

Returning to FIG. 8A, as shown by reference number 820, the UE 120 and the network node 110 may establish an RRC connection based at least in part on the PRACH transmission. In some aspects, the PRACH transmission may initiate a random access procedure, and the network node 110 and the UE 120 may communicate to establish an RRC connection in accordance with the random access procedure. For example, the PRACH communication may be msg1 in the four-step random access procedure described above in connection with FIG. 6. In this case, the network node 110 and the UE 120 may communicate to perform the remaining steps of the four-step random access procedure, as described above in connection with FIG. 6.

As indicated above, FIGS. 8A-8C are provided as an example. Other examples may differ from what is described with respect to FIGS. 8A-8C.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with SBFD PRACH transmission.

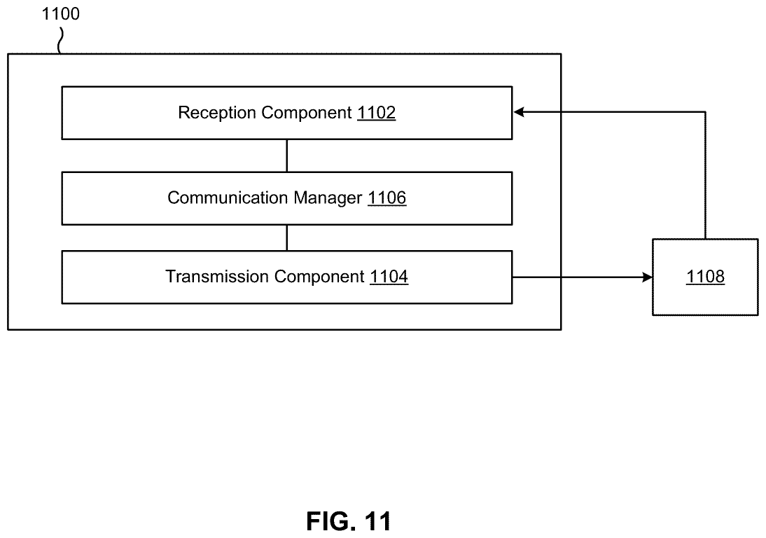

As shown in FIG. 9, in some aspects, process 900 may include receiving configuration information indicating a RACH configuration applicable to SBFD symbols (block 910). For example, the UE (e.g., using reception component 1102 and/or communication manager 1106, depicted in FIG. 11) may receive configuration information indicating a RACH configuration applicable to SBFD symbols, as described above in connection with reference number 810 of FIG. 8A and FIGS. 8B-8C.

As further shown in FIG. 9, in some aspects, process 900 may include transmitting a PRACH transmission in an RO of one or more ROs determined in accordance with the RACH configuration (block 920). For example, the UE (e.g., using transmission component 1104 and/or communication manager 1106, depicted in FIG. 11) may transmit a PRACH transmission in an RO of one or more ROs determined in accordance with the RACH configuration, as described above in connection with reference number 815 of FIG. 8A and FIGS. 8B-8C.

Process 900 may include additional aspects, such as any single aspect or any combination of aspects described below and/or in connection with one or more other processes described elsewhere herein.

In a first aspect, the one or more ROs, determined in accordance with the RACH configuration, are in an uplink sub-band in one or more SBFD symbols. In a second aspect, alone or in combination with the first aspect, the one or more ROs, determined in accordance with the RACH configuration, are in at least one of an uplink sub-band in one or more SBFD symbols or one or more uplink symbols. In a third aspects, alone or in combination with one or more of the first and second aspects, the PRACH transmission is a message 1 of a random access procedure.

In a fourth aspect, alone or in combination with one or more of the first through third aspects, the configuration information includes a generic RACH configuration IE that indicates global RACH parameters, and an additional RACH configuration IE associated with the SBFD symbols that indicates SBFD RACH parameters, including one or more SBFD RACH parameters that override one or more of the global RACH parameters for the SBFD symbols. In a fifth aspect, alone or in combination with one or more of the first through fourth aspects, the global RACH parameters include a first FDM parameter and a first starting frequency parameter, and the additional RACH configuration IE associated with the SBFD symbols indicates at least one of a second FDM parameter that overrides the first FDM parameter for the SBFD symbols, or a second starting frequency parameter that overrides the first starting frequency parameter for the SBFD symbols. In a sixth aspect, alone or in combination with one or more of the first through fifth aspects, the global RACH parameters further include a first power ramping parameter and a first target receive power parameter, and the additional RACH configuration IE associated with the SBFD symbols further indicates at least one of a second power ramping parameter that overrides the first power ramping parameter for the SBFD symbols, or a second target receive power parameter that overrides the first target receive power parameter for the SBFD symbols. In a seventh aspect, alone or in combination with one or more of the first through sixth aspects, the configuration information further includes another additional RACH configuration IE associated with the uplink symbols.

In an eighth aspect, alone or in combination with one or more of the first through seventh aspects, the configuration information indicates a first RACH configuration for uplink symbols and a second RACH configuration for the SBFD symbols. In a ninth aspect, alone or in combination with the first through eighth aspects, the first RACH configuration indicates a first mapping of SSBs to ROs in the uplink symbols, and the second RACH configuration indicates a second mapping of SSBs to ROs in uplink sub-bands of the SBFD symbols. In a tenth aspect, alone or in combination with one or more of the first through ninth aspects, the first RACH configuration indicates a first FDM parameter and a first starting frequency parameter, and the second RACH configuration indicates a second FDM parameter and a second starting frequency parameter.

In an eleventh aspect, alone or in combination with one or more of the first through tenth aspects, the configuration information includes a first generic RACH configuration IE associated with the uplink symbols, and a second generic RACH configuration IE associated with the SBFD symbols. In a twelfth aspect, alone or in combination with one or more of the first through eleventh aspects, the first generic RACH configuration IE indicates a first FDM parameter and a first starting frequency parameter, and the second generic RACH configuration IE indicates a second FDM parameter and a second starting frequency parameter. In a thirteenth aspect, alone or in combination with one or more of the first through twelfth aspects, the first RACH configuration indicates a first PRACH configuration index, and the second RACH configuration indicates a second PRACH configuration index.

In a fourteenth aspect, alone or in combination with one or more of the first through thirteenth aspects, ROs associated with the second RACH configuration that overlap with an SBFD slot are valid ROs for transmission of the PRACH transmission, ROs associated with the second RACH configuration that do not overlap with an SBFD slot are not valid ROs for transmission of the PRACH transmission, and the second RACH configuration indicates a mapping of SSBs to the valid ROs associated with the second RACH configuration. In a fifteenth aspect, alone or in combination with one or more of the first through fourteenth aspects, transmitting the PRACH transmission includes transmitting a first transmission of the PRACH transmission in an RO in an uplink sub-band in one or more SBFD symbols in accordance with the second RACH configuration, and transmitting a second transmission of the PRACH transmission in an RO in one or more uplink symbols in accordance with the first RACH configuration. In a sixteenth aspect, alone or in combination with one or more of the first through fifteenth aspects, process 900 includes selecting between the first RACH configuration and the second RACH configuration, wherein transmitting the PRACH transmission includes transmitting the PRACH transmission in an RO in one or more uplink symbols in accordance with the first RACH configuration in connection with selecting the first RACH configuration, or transmitting the PRACH transmission in an RO in an uplink sub-band in one or more SBFD symbols in accordance with the second RACH configuration in connection with selecting the second RACH configuration. In a seventeenth aspect, alone or in combination with one or more of the first through sixteenth aspects, selecting between the first RACH configuration and the second RACH configuration includes selecting between the first RACH configuration and the second RACH configuration based on which RO, among a next valid RO associated with a detected SSB in accordance with the first RACH configuration and a next valid RO associated with the detected SSB in accordance with the second RACH configuration, occurs first in time after the detected SSB.

In an eighteenth aspect, alone or in combination with one or more of the first through seventeenth aspects, transmitting the PRACH transmission includes transmitting the PRACH in an RO in an uplink sub-band in one or more SBFD symbols in accordance with the second RACH configuration based at least in part on a downlink channel measurement associated with at least one of an SSB satisfying or a CSI-RS a threshold. In a nineteenth aspect, alone or in combination with one or more of the first through eighteenth aspects, the second RACH configuration indicates the threshold. In a twentieth aspect, alone or in combination with one or more of the first through nineteenth aspects, transmitting the PRACH transmission includes transmitting multiple transmissions of the PRACH transmission in ROs in an uplink sub-band in one or more SBFD symbols in accordance with the second RACH configuration, and transmitting, in connection with a number of the multiple transmissions satisfying a threshold, the PRACH transmission in an RO in one or more uplink symbols in accordance with the first RACH configuration. In a twenty-first aspect, alone or in combination with one or more of the first through twentieth aspects, transmitting the PRACH transmission includes transmitting the PRACH transmission in an RO in an uplink sub-band in one or more SBFD symbols in accordance with the second RACH configuration based on the UE being SBFD-aware.

In a twenty-second aspect, alone or in combination with one or more of the first through twenty-first aspects, the configuration information is included in a SIB. In a twenty-third aspect, alone or in combination with one or more of the first through twenty-second aspects, the configuration information indicates a first set of PRACH preambles associated with uplink symbols and a second set of PRACH preambles associated with SBFD symbols, and transmitting the PRACH transmission includes transmitting a PRACH preamble, of the first set of PRACH preambles, in an RO in one or more uplink symbols, or transmitting a PRACH preamble, of the second set of PRACH preambles, in an RO in an uplink sub-band in one or more SBFD symbols.

In a twenty-fourth aspect, alone or in combination with one or more of the first through twenty-third aspects, the configuration information indicates a CFRA configuration linked with the second RACH configuration, and transmitting the PRACH transmission includes transmitting the PRACH transmission in an RO in an uplink sub-band in the one or more SBFD symbols in accordance with the second RACH configuration and the CFRA configuration. In a twenty-fifth aspect, alone or in combination with one or more of the first through twenty-fourth aspects, the configuration information indicates a CFRA configuration linked with the first RACH configuration or the second RACH configuration, and transmitting the PRACH transmission includes transmitting, based at least in part on the CFRA configuration being linked with the first RACH configuration, the RACH transmission in an RO in one or more uplink symbols in accordance with the first RACH configuration and the CFRA configuration, or transmitting, based at least in part on the CFRA configuration being linked with the second RACH configuration, the RACH transmission in an RO in an uplink sub-band in one or more SBFD symbols in accordance with the second RACH configuration and the CFRA configuration. In a twenty-sixth aspect, alone or in combination with one or more of the first through twenty-fifth aspects, the configuration information indicates a CFRA configuration linked with the first RACH configuration and the second RACH configuration, and transmitting the PRACH transmission includes transmitting the PRACH transmission in an RO in one or more uplink symbols in accordance with the first RACH configuration and the CFRA configuration or in an RO in an uplink sub-band in one or more SBFD symbols in accordance with the second RACH configuration and the CFRA configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with SBFD PRACH transmission.

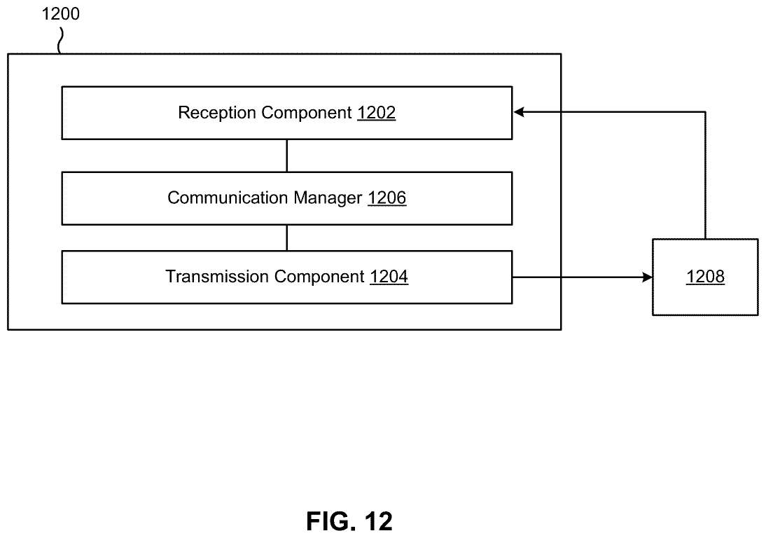

As shown in FIG. 10, in some aspects, process 1000 may include transmitting configuration information indicating a RACH configuration applicable to SBFD symbols (block 1010). For example, the network node (e.g., using transmission component 1204 and/or communication manager 1206, depicted in FIG. 12) may transmit configuration information indicating a RACH configuration applicable to SBFD symbols, as described above in connection with reference number 810 of FIG. 8A and FIGS. 8B-8C.

As further shown in FIG. 10, in some aspects, process 1000 may include receiving a PRACH transmission in an RO of one or more ROs determined in accordance with the RACH configuration (block 1020). For example, the network node (e.g., using reception component 1202 and/or communication manager 1206, depicted in FIG. 12) may receive a PRACH transmission in an RO of one or more ROs determined in accordance with the RACH configuration, as described above in connection with reference number 815 of FIG. 8A and FIGS. 8B-8C.

Process 1000 may include additional aspects, such as any single aspect or any combination of aspects described below and/or in connection with one or more other processes described elsewhere herein.

In a first aspect, the one or more ROs, determined in accordance with the RACH configuration, are in an uplink sub-band in one or more SBFD symbols. In a second aspect, alone or in combination with the first aspect, the one or more ROs, determined in accordance with the RACH configuration, are in at least one of an uplink sub-band in one or more SBFD symbols or one or more uplink symbols. In a third aspects, alone or in combination with one or more of the first and second aspects, the PRACH transmission is a message 1 of a random access procedure.

In a fourth aspect, alone or in combination with one or more of the first through third aspects, the configuration information includes a generic RACH configuration IE that indicates global RACH parameters, and an additional RACH configuration IE associated with the SBFD symbols that indicates SBFD RACH parameters, including one or more SBFD RACH parameters that override one or more of the global RACH parameters for the SBFD symbols. In a fifth aspect, alone or in combination with one or more of the first through fourth aspects, the global RACH parameters include a first FDM parameter and a first starting frequency parameter, and the additional RACH configuration IE associated with the SBFD symbols indicates at least one of a second FDM parameter that overrides the first FDM parameter for the SBFD symbols, or a second starting frequency parameter that overrides the first starting frequency parameter for the SBFD symbols. In a sixth aspect, alone or in combination with one or more of the first through fifth aspects, the global RACH parameters further include a first power ramping parameter and a first target receive power parameter, and the additional RACH configuration IE associated with the SBFD symbols further indicates at least one of a second power ramping parameter that overrides the first power ramping parameter for the SBFD symbols, or a second target receive power parameter that overrides the first target receive power parameter for the SBFD symbols. In a seventh aspect, alone or in combination with one or more of the first through sixth aspects, the configuration information further includes another additional RACH configuration IE associated with the uplink symbols.

In an eighth aspect, alone or in combination with one or more of the first through seventh aspects, the configuration information indicates a first RACH configuration for uplink symbols and a second RACH configuration for the SBFD symbols. In a ninth aspect, alone or in combination with the first through eighth aspects, the first RACH configuration indicates a first mapping of SSBs to ROs in the uplink symbols, and the second RACH configuration indicates a second mapping of SSBs to ROs in uplink sub-bands of the SBFD symbols. In a tenth aspect, alone or in combination with one or more of the first through ninth aspects, the first RACH configuration indicates a first FDM parameter and a first starting frequency parameter, and the second RACH configuration indicates a second FDM parameter and a second starting frequency parameter.

In an eleventh aspect, alone or in combination with one or more of the first through tenth aspects, the configuration information includes a first generic RACH configuration IE associated with the uplink symbols, and a second generic RACH configuration IE associated with the SBFD symbols. In a twelfth aspect, alone or in combination with one or more of the first through eleventh aspects, the first generic RACH configuration IE indicates a first FDM parameter and a first starting frequency parameter, and the second generic RACH configuration IE indicates a second FDM parameter and a second starting frequency parameter. In a thirteenth aspect, alone or in combination with one or more of the first through twelfth aspects, the first RACH configuration indicates a first PRACH configuration index, and the second RACH configuration indicates a second PRACH configuration index.

In a fourteenth aspect, alone or in combination with one or more of the first through thirteenth aspects, ROs associated with the second RACH configuration that overlap with an SBFD slot are valid ROs for of the PRACH transmission, ROs associated with the second RACH configuration that do not overlap with an SBFD slot are not valid ROs for of the PRACH transmission, and the second RACH configuration indicates a mapping of SSBs to the valid ROs associated with the second RACH configuration. In a fifteenth aspect, alone or in combination with one or more of the first through fourteenth aspects, receiving the PRACH transmission includes receiving the PRACH in an RO in an uplink sub-band in one or more SBFD symbols in accordance with the second RACH configuration based at least in part on a downlink channel measurement associated with at least one of an SSB or a CSI-RS satisfying a threshold. In a sixteenth aspect, alone or in combination with one or more of the first through fifteenth aspects, the second RACH configuration indicates the threshold. In a seventeenth aspect, alone or in combination with one or more of the first through sixteenth aspects, receiving the PRACH transmission includes receiving, from a UE, the PRACH transmission in an RO in an uplink sub-band in one or more SBFD symbols in accordance with the second RACH configuration in connection with the UE being SBFD-aware.

In an eighteenth aspect, alone or in combination with one or more of the first through seventeenth aspects, the configuration information is included in a SIB. In a nineteenth aspect, alone or in combination with one or more of the first through eighteenth aspects, the configuration information indicates a first set of PRACH preambles associated with uplink symbols and a second set of PRACH preambles associated with SBFD symbols, and receiving the PRACH transmission includes receiving a PRACH preamble, of the first set of PRACH preambles, in an RO in one or more uplink symbols, or receiving a PRACH preamble, of the second set of PRACH preambles, in an RO in an uplink sub-band in one or more SBFD symbols.

In a twentieth aspect, alone or in combination with one or more of the first through nineteenth aspects, the configuration information indicates a CFRA configuration linked with the second RACH configuration, and receiving the PRACH transmission includes receiving the PRACH transmission in an RO in an uplink sub-band in one or more SBFD symbols in accordance with the second RACH configuration and the CFRA configuration. In a twenty-first aspect, alone or in combination with one or more of the first through twentieth aspects, the configuration information indicates a CFRA configuration linked with the first RACH configuration or the second RACH configuration, and receiving the PRACH transmission includes receiving, based at least in part on the CFRA configuration being linked with the first RACH configuration, the RACH transmission in an RO in one or more uplink symbols in accordance with the first RACH configuration and the CFRA configuration, or receiving, based at least in part on the CFRA configuration being linked with the second RACH configuration, the RACH transmission in an RO in an uplink sub-band in one or more SBFD symbols in accordance with the second RACH configuration and the CFRA configuration. In a twenty-second aspect, alone or in combination with one or more of the first through twenty-first aspects, the configuration information indicates a CFRA configuration linked with the first RACH configuration and the second RACH configuration, and receiving the PRACH transmission includes receiving the PRACH transmission in an RO in one or more uplink symbols in accordance with the first RACH configuration and the CFRA configuration or in an RO in an uplink sub-band in one or more SBFD symbols in accordance with the second RACH configuration and the CFRA configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 8A-8C Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive configuration information indicating a RACH configuration applicable to SBFD symbols. The transmission component 1104 may transmit a PRACH transmission in an RO of one or more ROs in accordance with the RACH configuration.

The communication manager 1106 may select between a first RACH configuration for uplink symbols and a second RACH configuration for SBFD symbols.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 8A-8C. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit configuration information indicating a RACH configuration applicable to SBFD symbols. The reception component 1202 may receive a PRACH transmission in an RO of one or more ROs determined in accordance with the RACH configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving configuration information indicating a random access channel (RACH) configuration applicable to sub-band full-duplex (SBFD) symbols; and transmitting a physical random access channel (PRACH) transmission in a RACH occasion (RO) of one or more ROs determined in accordance with the RACH configuration.

Aspect 2: The method of Aspect 1, wherein the one or more ROs, determined in accordance with the RACH configuration, are in an uplink sub-band in one or more SBFD symbols.

Aspect 3: The method of Aspect 1, wherein the one or more ROs, determined in accordance with the RACH configuration, are in at least one of an uplink sub-band in one or more SBFD symbols or one or more uplink symbols.

Aspect 4: The method of any of Aspects 1-3, wherein the PRACH transmission is a message 1 of a random access procedure.

Aspect 5: The method of any of Aspects 1-4, wherein the configuration information includes: a generic RACH configuration information element (IE) that indicates global RACH parameters, and an additional RACH configuration IE associated with the SBFD symbols that indicates SBFD RACH parameters, including one or more SBFD RACH parameters that override one or more of the global RACH parameters for the SBFD symbols.

Aspect 6: The method of Aspect 5, wherein the global RACH parameters include a first frequency division multiplexing (FDM) parameter and a first starting frequency parameter, and wherein the additional RACH configuration IE associated with the SBFD symbols indicates at least one of: a second FDM parameter that overrides the first FDM parameter for the SBFD symbols, or a second starting frequency parameter that overrides the first starting frequency parameter for the SBFD symbols.

Aspect 7: The method of Aspect 6, wherein the global RACH parameters further include a first power ramping parameter and a first target receive power parameter, and wherein the additional RACH configuration IE associated with the SBFD symbols further indicates at least one of: a second power ramping parameter that overrides the first power ramping parameter for the SBFD symbols, or a second target receive power parameter that overrides the first target receive power parameter for the SBFD symbols.

Aspect 8: The method of any of Aspects 5-7, wherein the configuration information further includes another additional RACH configuration IE associated with the uplink symbols.

Aspect 9: The method of any of Aspects 1-8, wherein the configuration information indicates a first RACH configuration for uplink symbols and a second RACH configuration for the SBFD symbols.

Aspect 10: The method of Aspect 9, wherein the first RACH configuration indicates a first mapping of synchronization symbol blocks (SSBs) to ROs in the uplink symbols, and wherein the second RACH configuration indicates a second mapping of SSBs to ROs in uplink sub-bands of the SBFD symbols.

Aspect 11: The method of any of Aspects 9-10, wherein the first RACH configuration indicates a first frequency division multiplexing (FDM) parameter and a first starting frequency parameter, and wherein the second RACH configuration indicates a second FDM parameter and a second starting frequency parameter.

Aspect 12: The method of any of Aspects 9-11, wherein the configuration information includes: a first generic RACH configuration information element (IE) associated with the uplink symbols; and a second generic RACH configuration IE associated with the SBFD symbols.

Aspect 13: The method of Aspect 12, wherein the first generic RACH configuration IE indicates a first frequency division multiplexing (FDM) parameter and a first starting frequency parameter, and wherein the second generic RACH configuration IE indicates a second FDM parameter and a second starting frequency parameter.

Aspect 14: The method of any of Aspects 9-13, wherein the first RACH configuration indicates a first PRACH configuration index, and wherein the second RACH configuration indicates a second PRACH configuration index.

Aspect 15: The method of any of Aspects 9-14, wherein ROs associated with the second RACH configuration that overlap with an SBFD slot are valid ROs for transmission of the PRACH transmission, wherein ROs associated with the second RACH configuration that do not overlap with an SBFD slot are not valid ROs for transmission of the PRACH transmission, and wherein the second RACH configuration indicates a mapping of SSBs to the valid ROs associated with the second RACH configuration.

Aspect 16: The method of Aspect 15, wherein transmitting the PRACH transmission comprises: transmitting a first transmission of the PRACH transmission in an RO in an uplink sub-band in one or more SBFD symbols in accordance with the second RACH configuration; and transmitting a second transmission of the PRACH transmission in an RO in one or more uplink symbols in accordance with the first RACH configuration.

Aspect 17: The method of any of Aspects 15-16, further comprising selecting between the first RACH configuration and the second RACH configuration, wherein transmitting the PRACH transmission comprises: transmitting the PRACH transmission in an RO in one or more uplink symbols in accordance with the first RACH configuration in connection with selecting the first RACH configuration; or transmitting the PRACH transmission in an RO in an uplink sub-band in one or more SBFD symbols in accordance with the second RACH configuration in connection with selecting the second RACH configuration.

Aspect 18: The method of Aspect 17, wherein selecting between the first RACH configuration and the second RACH configuration comprises: selecting between the first RACH configuration and the second RACH configuration based on which RO, among a next valid RO associated with a detected synchronization signal block (SSB) in accordance with the first RACH configuration and a next valid RO associated with the detected SSB in accordance with the second RACH configuration, occurs first in time after the detected SSB.

Aspect 19: The method of any of Aspects 9-18, wherein transmitting the PRACH transmission comprises: transmitting the PRACH in an RO in an uplink sub-band in one or more SBFD symbols in accordance with the second RACH configuration based at least in part on a downlink channel measurement associated with at least one of a synchronization signal block (SSB) or a channel state information (CSI) reference signal (CSI-RS) satisfying a threshold.

Aspect 20: The method of Aspect 19, wherein the second RACH configuration indicates the threshold.

Aspect 21: The method of any of Aspects 9-20, wherein transmitting the PRACH transmission comprises: transmitting multiple transmissions of the PRACH transmission in ROs in an uplink sub-band in one or more SBFD symbols in accordance with the second RACH configuration; and transmitting, in connection with a number of the multiple transmissions satisfying a threshold, the PRACH transmission in an RO in one or more uplink symbols in accordance with the first RACH configuration.

Aspect 22: The method of any of Aspects 9-21, wherein transmitting the PRACH transmission comprises: transmitting the PRACH transmission in an RO in an uplink sub-band in one or more SBFD symbols in accordance with the second RACH configuration based on the UE being SBFD-aware.

Aspect 23: The method of any of Aspects 9-22, wherein the configuration information indicates a contention-free random access (CFRA) configuration linked with the second RACH configuration, and wherein transmitting the PRACH transmission comprises: transmitting the PRACH transmission in an RO in an uplink sub-band in one or more SBFD symbols in accordance with the second RACH configuration and the CFRA configuration.

Aspect 24: The method of any of Aspects 9-23, wherein the configuration information indicates a contention-free random access (CFRA) configuration linked with the first RACH configuration or the second RACH configuration, and wherein transmitting the PRACH transmission comprises: transmitting, based at least in part on the CFRA configuration being linked with the first RACH configuration, the RACH transmission in an RO in one or more uplink symbols in accordance with the first RACH configuration and the CFRA configuration; or transmitting, based at least in part on the CFRA configuration being linked with the second RACH configuration, the RACH transmission in an RO in an uplink sub-band in one or more SBFD symbols in accordance with the second RACH configuration and the CFRA configuration.

Aspect 25: The method of any of Aspects 1-22, wherein the configuration information indicates a contention-free random access (CFRA) configuration linked with the first RACH configuration and the second RACH configuration, and wherein transmitting the PRACH transmission comprises: transmitting the PRACH transmission in an RO in one or more uplink symbols in accordance with the first RACH configuration and the CFRA configuration or in an RO in an uplink sub-band in one or more SBFD symbols in accordance with the second RACH configuration and the CFRA configuration.

Aspect 26: The method of any of Aspects 1-25, wherein the configuration information is included in a system information block (SIB).

Aspect 27: The method of any of Aspects 1-26, wherein the configuration information indicates a first set of PRACH preambles associated with uplink symbols and a second set of PRACH preambles associated with SBFD symbols, and wherein transmitting the PRACH transmission comprises: transmitting a PRACH preamble, of the first set of PRACH preambles, in an RO in one or more uplink symbols; or transmitting a PRACH preamble, of the second set of PRACH preambles, in an RO in an uplink sub-band in one or more SBFD symbols.

Aspect 28: A method of wireless communication performed by a network node, comprising: transmitting configuration information indicating a random access channel (RACH) configuration applicable to sub-band full-duplex (SBFD) symbols; and receiving a physical random access channel (PRACH) transmission in a RACH occasion (RO) of one or more ROs determined in accordance with the RACH configuration.

Aspect 29: The method of Aspect 28, wherein the one or more ROs, determined in accordance with the RACH configuration, are in an uplink sub-band in one or more SBFD symbols.

Aspect 30: The method of Aspect 28, wherein the one or more ROs, determined in accordance with the RACH configuration, are in at least one of an uplink sub-band in one or more SBFD symbols or one or more uplink symbols.

Aspect 31: The method of any of Aspects 28-30, wherein the PRACH transmission is a message 1 of a random access procedure.

Aspect 32: The method of any of Aspects 28-31, wherein the configuration information includes: a generic RACH configuration information element (IE) that indicates global RACH parameters, and an additional RACH configuration IE associated with the SBFD symbols that indicates SBFD RACH parameters, including one or more SBFD RACH parameters that override one or more of the global RACH parameters for the SBFD symbols.

Aspect 33: The method of Aspect 32, wherein the global RACH parameters include a first frequency division multiplexing (FDM) parameter and a first starting frequency parameter, and wherein the additional RACH configuration IE associated with the SBFD symbols indicates at least one of: a second FDM parameter that overrides the first FDM parameter for the SBFD symbols, or a second starting frequency parameter that overrides the first starting frequency parameter for the SBFD symbols.

Aspect 34: The method of Aspect 33, wherein the global RACH parameters further include a first power ramping parameter and a first target receive power parameter, and wherein the additional RACH configuration IE associated with the SBFD symbols further indicates at least one of: a second power ramping parameter that overrides the first power ramping parameter for the SBFD symbols, or a second target receive power parameter that overrides the first target receive power parameter for the SBFD symbols.

Aspect 35: The method of any of Aspects 32-34, wherein the configuration information further includes another additional RACH configuration IE associated with the uplink symbols.

Aspect 36: The method of any of Aspects 28-35, wherein the configuration information indicates a first RACH configuration for uplink symbols and a second RACH configuration for the SBFD symbols.

Aspect 37: The method of Aspect 36, wherein the first RACH configuration indicates a first mapping of synchronization symbol blocks (SSBs) to ROs in the uplink symbols, and wherein the second RACH configuration indicates a second mapping of SSBs to ROs in uplink sub-bands of the SBFD symbols.

Aspect 38: The method of any of Aspects 36-37, wherein the first RACH configuration indicates a first frequency division multiplexing (FDM) parameter and a first starting frequency parameter, and wherein the second RACH configuration indicates a second FDM parameter and a second starting frequency parameter.

Aspect 39: The method of any of Aspects 36-38, wherein the configuration information includes: a first generic RACH configuration information element (IE) associated with the uplink symbols; and a second generic RACH configuration IE associated with the SBFD symbols.

Aspect 40: The method of Aspect 39, wherein the first generic RACH configuration IE indicates a first frequency division multiplexing (FDM) parameter and a first starting frequency parameter, and wherein the second generic RACH configuration IE indicates a second FDM parameter and a second starting frequency parameter.

Aspect 41: The method of any of Aspects 36-40, wherein the first RACH configuration indicates a first PRACH configuration index, and wherein the second RACH configuration indicates a second PRACH configuration index.

Aspect 42: The method of any of Aspects 36-41, wherein ROs associated with the second RACH configuration that overlap with an SBFD slot are valid ROs for of the PRACH transmission, wherein ROs associated with the second RACH configuration that do not overlap with an SBFD slot are not valid ROs for of the PRACH transmission, and wherein the second RACH configuration indicates a mapping of SSBs to the valid ROs associated with the second RACH configuration.

Aspect 43: The method of any of Aspects 36-42, wherein receiving the PRACH transmission comprises: receiving the PRACH in an RO in an uplink sub-band in one or more SBFD symbols in accordance with the second RACH configuration based at least in part on a downlink channel measurement associated with at least one of a synchronization signal block (SSB) or a channel state information (CSI) reference signal (CSI-RS) satisfying a threshold.

Aspect 44: The method of Aspect 43, wherein the second RACH configuration indicates the threshold.

Aspect 45: The method of any of Aspects 36-44, wherein receiving the PRACH transmission comprises: receiving, from a user equipment (UE), the PRACH transmission in an RO in an uplink sub-band in one or more SBFD symbols in accordance with the second RACH configuration in connection with the UE being SBFD-aware.

Aspect 46: The method of any of Aspects 36-45, wherein the configuration information indicates a contention-free random access (CFRA) configuration linked with the second RACH configuration, and wherein receiving the PRACH transmission comprises: receiving the PRACH transmission in an RO in an uplink sub-band in one or more SBFD symbols in accordance with the second RACH configuration and the CFRA configuration.

Aspect 47: The method of any of Aspects 36-46, wherein the configuration information indicates a contention-free random access (CFRA) configuration linked with the first RACH configuration or the second RACH configuration, and wherein receiving the PRACH transmission comprises: receiving, based at least in part on the CFRA configuration being linked with the first RACH configuration, the RACH transmission in an RO in one or more uplink symbols in accordance with the first RACH configuration and the CFRA configuration; or receiving, based at least in part on the CFRA configuration being linked with the second RACH configuration, the RACH transmission in an RO in an uplink sub-band in one or more SBFD symbols in accordance with the second RACH configuration and the CFRA configuration.

Aspect 48: The method of any of Aspects 36-45, wherein the configuration information indicates a contention-free random access (CFRA) configuration linked with the first RACH configuration and the second RACH configuration, and wherein receiving the PRACH transmission comprises: receiving the PRACH transmission in an RO in one or more uplink symbols in accordance with the first RACH configuration and the CFRA configuration or in an RO in an uplink sub-band in one or more SBFD symbols in accordance with the second RACH configuration and the CFRA configuration.

Aspect 49: The method of any of Aspects 28-48, wherein the configuration information is included in a system information block (SIB).

Aspect 50: The method of any of Aspects 28-49, wherein the configuration information indicates a first set of PRACH preambles associated with uplink symbols and a second set of PRACH preambles associated with SBFD symbols, and wherein receiving the PRACH transmission comprises: receiving a PRACH preamble, of the first set of PRACH preambles, in an RO in one or more uplink symbols; or receiving a PRACH preamble, of the second set of PRACH preambles, in an RO in an uplink sub-band in one or more SBFD symbols.

Aspect 51: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-50.

Aspect 52: An apparatus for wireless communication at a device, the apparatus comprising one or more memories and one or more processors coupled to the one or more memories, the one or more processors configured to cause the device to perform the method of one or more of Aspects 1-50.

Aspect 53: An apparatus for wireless communication, the apparatus comprising at least one means for performing the method of one or more of Aspects 1-50.

Aspect 54: A non-transitory computer-readable medium storing code for wireless communication, the code comprising instructions executable by one or more processors to perform the method of one or more of Aspects 1-50.

Aspect 55: A non-transitory computer-readable medium storing a set of instructions for wireless communication, the set of instructions comprising one or more instructions that, when executed by one or more processors of a device, cause the device to perform the method of one or more of Aspects 1-50.

Aspect 56: A device for wireless communication, the device comprising a processing system that includes one or more processors and one or more memories coupled with the one or more processors, the processing system configured to cause the device to perform the method of one or more of Aspects 1-50.

Aspect 57: An apparatus for wireless communication at a device, the apparatus comprising one or more memories and one or more processors coupled to the one or more memories, the one or more processors individually or collectively configured to cause the device to perform the method of one or more of Aspects 1-50.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive configuration information indicating a random access channel (RACH) configuration applicable to sub-band full-duplex (SBFD) symbols; and
transmit a physical random access channel (PRACH) transmission in a RACH occasion (RO) of one or more ROs determined in accordance with the RACH configuration.

2. The UE of claim 1, wherein the one or more ROs, determined in accordance with the RACH configuration, are in an uplink sub-band in one or more SBFD symbols.

3. The UE of claim 1, wherein the one or more ROs, determined in accordance with the RACH configuration, are in at least one of an uplink sub-band in one or more SBFD symbols or one or more uplink symbols.

4. The UE of claim 1, wherein the configuration information includes:
a generic RACH configuration information element (IE) that indicates global RACH parameters, and
an additional RACH configuration IE associated with the SBFD symbols that indicates SBFD RACH parameters, including one or more SBFD RACH parameters that override one or more of the global RACH parameters for the SBFD symbols.

5. The UE of claim 4, wherein the global RACH parameters include a first frequency division multiplexing (FDM) parameter and a first starting frequency parameter, and
wherein the additional RACH configuration IE associated with the SBFD symbols indicates at least one of:
a second FDM parameter that overrides the first FDM parameter for the SBFD symbols, or
a second starting frequency parameter that overrides the first starting frequency parameter for the SBFD symbols.

6. The UE of claim 5, wherein the global RACH parameters further include a first power ramping parameter and a first target receive power parameter, and
wherein the additional RACH configuration IE associated with the SBFD symbols further indicates at least one of:
a second power ramping parameter that overrides the first power ramping parameter for the SBFD symbols, or
a second target receive power parameter that overrides the first target receive power parameter for the SBFD symbols.

7. The UE of claim 1, wherein the configuration information indicates a first RACH configuration for uplink symbols and a second RACH configuration for the SBFD symbols.

8. The UE of claim 7, wherein the configuration information includes:
a first generic RACH configuration information element (IE) associated with uplink symbols; and
a second generic RACH configuration IE associated with the SBFD symbols.

9. The UE of claim 8, wherein the first generic RACH configuration IE indicates a first frequency division multiplexing (FDM) parameter and a first starting frequency parameter, and
wherein the second generic RACH configuration IE indicates a second FDM parameter and a second starting frequency parameter.

10. The UE of claim 7, wherein the first RACH configuration indicates a first PRACH configuration index, and wherein the second RACH configuration indicates a second PRACH configuration index.

11. The UE of claim 7, wherein ROs associated with the second RACH configuration that overlap with an SBFD slot are valid ROs for transmission of the PRACH transmission,
wherein ROs associated with the second RACH configuration that do not overlap with an SBFD slot are not valid ROs for transmission of the PRACH transmission, and
wherein the second RACH configuration indicates a mapping of SSBs to the valid ROs associated with the second RACH configuration.

12. The UE of claim 11, wherein the one or more processors, to cause the UE to transmit the PRACH transmission, are configured to cause the UE to:
transmit a first transmission of the PRACH transmission in an RO in an uplink sub-band in one or more SBFD symbols in accordance with the second RACH configuration; and
transmit a second transmission of the PRACH transmission in an RO in one or more uplink symbols in accordance with the first RACH configuration.

13. The UE of claim 11, wherein the one or more processors are further configured to cause the UE to select between the first RACH configuration and the second RACH configuration, wherein transmitting the PRACH transmission comprises:
transmit the PRACH transmission in an RO in one or more uplink symbols in accordance with the first RACH configuration in connection with selecting the first RACH configuration; or
transmit the PRACH transmission in an RO in an uplink sub-band in one or more SBFD symbols in accordance with the second RACH configuration in connection with selecting the second RACH configuration.

14. The UE of claim 13, wherein the one or more processors, to cause the UE to select between the first RACH configuration and the second RACH configuration, are configured to cause the UE to:
select between the first RACH configuration and the second RACH configuration based on which RO, among a next valid RO associated with a detected synchronization signal block (SSB) in accordance with the first RACH configuration and a next valid RO associated with the detected SSB in accordance with the second RACH configuration, occurs first in time after the detected SSB.

15. The UE of claim 7, wherein the one or more processors, to cause the UE to transmit the PRACH transmission, are configured to cause the UE to:
transmit the PRACH in an RO in an uplink sub-band in one or more SBFD symbols in accordance with the second RACH configuration based at least in part on a downlink channel measurement associated with at least one of a synchronization signal block (SSB) or a channel state information (CSI) reference signal (CSI-RS) satisfying a threshold.

16. The UE of claim 7, wherein the one or more processors, to cause the UE to transmit the PRACH transmission, are configured to cause the UE to:
transmit multiple transmissions of the PRACH transmission in ROs in an uplink sub-band in one or more SBFD symbols in accordance with the second RACH configuration; and
transmit, in connection with a number of the multiple transmissions satisfying a threshold, the PRACH transmission in an RO in one or more uplink symbols in accordance with the first RACH configuration.

17. The UE of claim 7, wherein the one or more processors, to cause the UE to transmit the PRACH transmission, are configured to cause the UE to:
transmit the PRACH transmission in an RO in an uplink sub-band in one or more SBFD symbols in accordance with the second RACH configuration based on the UE being SBFD-aware.

18. The UE of claim 1, wherein the configuration information indicates a first set of PRACH preambles associated with uplink symbols and a second set of PRACH preambles associated with SBFD symbols, and wherein the one or more processors, to cause the UE to transmit the PRACH transmission, are configured to cause the UE to:
transmit a PRACH preamble, of the first set of PRACH preambles, in an RO in one or more uplink symbols; or
transmit a PRACH preamble, of the second set of PRACH preambles, in an RO in an uplink sub-band in one or more SBFD symbols.

19. A network node for wireless communication, comprising:
one or more memories; and
one or more processors, coupled to the one or more memories, configured to cause the network node to:
transmit configuration information indicating a random access channel (RACH) configuration applicable to sub-band full-duplex (SBFD) symbols; and
receive a physical random access channel (PRACH) transmission in a RACH occasion (RO) of one or more ROs determined in accordance with the RACH configuration.

20. A method of wireless communication performed by a user equipment (UE), comprising:
receiving configuration information indicating a random access channel (RACH) configuration applicable to sub-band full-duplex (SBFD) symbols; and
transmitting a physical random access channel (PRACH) transmission in a RACH occasion (RO) of one or more ROs determined in accordance with the RACH configuration.
